(19) United States
(12) Patent Application Publication
(10) Pub. No.: US 2024/0196418 A1
(43) Pub. Date: Jun. 13, 2024

(54) COEXISTENCE OF BROADCAST COMMUNICATION PROTOCOLS

(71) Applicant: QUALCOMM Incorporated, San Diego, CA (US)

(72) Inventors: Ayan Sengupta, San Diego, CA (US); Alberto Rico Alvarino, San Diego, CA (US); Le Liu, San Jose, CA (US)

(21) Appl. No.: 18/064,868

(22) Filed: Dec. 12, 2022

(51) Int. Cl. H04W 72/30; H04W 72/541

(52) U.S. Cl. CPC H04W 72/30; H04W 72/541

(57) ABSTRACT

Methods, systems, and devices for wireless communications are described. Some wireless communications systems may support coexistence of broadcast communication protocols. In such cases, a first network node, such as a network entity, may broadcast a cell acquisition subframe (CAS) in accordance with a first broadcast communication protocol whose frequency resources overlap with frequency resources allocated in accordance with a second broadcast communication protocol. The CAS may indicate a modification to transmission of one or more subsequent CASs in accordance with the first broadcast communication protocol. For example, the modification may be a muting pattern, an updated periodicity, or both. As such, the first network node may broadcast, in accordance with the first broadcast communication protocol, the one or more subsequent CASs, wherein the one or more subsequent CASs are time division multiplexed with communications associated with the second broadcast communication protocol in accordance with the modification.

### INTRODUCTION

The following relates to wireless communications, including coexistence of broadcast communication protocols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support coexistence of broadcast communication protocols. Generally, the techniques described herein may enable a first network node, such as a network entity, to broadcast, in accordance with a first broadcast communication protocol, one or more messages, such as a cell acquisition subframe (CAS), based on an indicated modification to support coexistence with a second broadcast communication protocol. For example, the first network node may broadcast a CAS in accordance with a first broadcast communication protocol indicating a modification to transmission of one or more subsequent CASs in accordance with the first broadcast communication protocol. In such cases, frequency resources allocated in accordance with the first broadcast communication protocol may overlap with frequency resources allocated in accordance with the second broadcast communication protocol. Additionally, the first network entity may broadcast, in accordance with the first broadcast communication protocol, the one or more subsequent CASs, where the one or more subsequent CASs are time division multiplexed (TDMed) with communications associated with the second broadcast communication protocol in accordance with the modification.

A method for wireless communication at a first network node is described. The method may include broadcasting a CAS in accordance with a first broadcast communication protocol, where the CAS indicates a modification to transmission of one or more subsequent CASs in accordance with the first broadcast communication protocol and broadcasting, in accordance with the first broadcast communication protocol, the one or more subsequent CASs.

An apparatus for wireless communication at a first network node is described. The apparatus may include a processor, memory coupled with the processor, and instructions stored in the memory. The instructions may be executable by the processor to cause the apparatus to broadcast a CAS in accordance with a first broadcast communication protocol, where the CAS indicates a modification to transmission of one or more subsequent CASs in accordance with the first broadcast communication protocol and broadcasting, in accordance with the first broadcast communication protocol, the one or more subsequent CASs.

Another apparatus for wireless communication at a first network node is described. The apparatus may include means for broadcasting a CAS in accordance with a first broadcast communication protocol, where the CAS indicates a modification to transmission of one or more subsequent CASs in accordance with the first broadcast communication protocol and means for broadcasting, in accordance with the first broadcast communication protocol, the one or more subsequent CASs.

A non-transitory computer-readable medium storing code for wireless communication at a first network node is described. The code may include instructions executable by a processor to broadcast a CAS in accordance with a first broadcast communication protocol, where the CAS indicates a modification to transmission of one or more subsequent CASs in accordance with the first broadcast communication protocol and broadcasting, in accordance with the first broadcast communication protocol, the one or more subsequent CASs.

In some examples of the method, apparatuses, and non-transitory computer-readable medium described herein, broadcasting the one or more subsequent CASs may include operations, features, means, or instructions for broadcasting the one or more subsequent CASs in accordance with a muting pattern, where the modification may be the muting pattern, and where the muting pattern cancels transmission of scheduled CASs during one or more sets of time resources.

Some examples of the method, apparatuses, and non-transitory computer-readable medium described herein may further include operations, features, means, or instructions for refraining from transmission of any communications in accordance with the first broadcast communication protocol during the one or more sets of time resources in accordance with the muting pattern.

Some examples of the method, apparatuses, and non-transitory computer-readable medium described herein may further include operations, features, means, or instructions for transmitting one or more data messages in accordance with the first broadcast communication protocol during the one or more sets of time resources in accordance with the muting pattern.

Some examples of the method, apparatuses, and non-transitory computer-readable medium described herein may further include operations, features, means, or instructions for refraining from transmission of the scheduled CASs, MCCH messages, or MSI messages in accordance with the first broadcast communication protocol during the one or more sets of time resources in accordance with the muting pattern.

In some examples of the method, apparatuses, and non-transitory computer-readable medium described herein, broadcasting, outside of the one or more sets of time resources, one or more MCCH messages or one or more MSI messages scheduling the one or more data messages in accordance with the first broadcast communication protocol during the one or more sets of time resources.

In some examples of the method, apparatuses, and non-transitory computer-readable medium described herein, the CAS includes a bitmap that indicates the muting pattern.

In some examples of the method, apparatuses, and non-transitory computer-readable medium described herein, broadcasting the CAS that indicates the modification to transmission of the one or more subsequent CASs may include operations, features, means, or instructions for broadcasting an indication of the muting pattern from a set of muting patterns, where set of muting patterns may be associated with a configuration of the first network node.

In some examples of the method, apparatuses, and non-transitory computer-readable medium described herein, broadcasting the one or more subsequent CASs may include operations, features, means, or instructions for broadcasting the one or more subsequent CASs in accordance with a periodicity, where the modification may be the periodicity.

In some examples of the method, apparatuses, and non-transitory computer-readable medium described herein, broadcasting the one or more subsequent CASs may include operations, features, means, or instructions for broadcasting one or more MCCH messages associated with the one or more subsequent CASs in accordance with one or more starting locations, one or more offsets, or one or more modification duration periods, where the modification further indicates the one or more starting locations, the one or more offsets, or the one or more modification duration periods.

In some examples of the method, apparatuses, and non-transitory computer-readable medium described herein, the CAS that indicates the modification to the transmission of the one or more subsequent CASs in accordance with the first broadcast communication protocol may be an anchor CAS.

Some examples of the method, apparatuses, and non-transitory computer-readable medium described herein may further include operations, features, means, or instructions for broadcasting an indication of the anchor CAS.

In some examples of the method, apparatuses, and non-transitory computer-readable medium described herein, the anchor CAS may be based on a configuration of the first network node.

In some examples of the method, apparatuses, and non-transitory computer-readable medium described herein, the one or more subsequent CASs may be indicated via the anchor CAS.

In some examples of the method, apparatuses, and non-transitory computer-readable medium described herein, the one or more subsequent CASs may be associated with the anchor CAS.

Some examples of the method, apparatuses, and non-transitory computer-readable medium described herein may further include operations, features, means, or instructions for broadcasting a MIB during a TTI, where a duration of the TTI may be based on the periodicity.

In some examples of the method, apparatuses, and non-transitory computer-readable medium described herein, time or frequency resources allocated in accordance with the first broadcast communication protocol may be multiplexed, shared, or overlapped with time or frequency resources allocated in accordance with a second broadcast communication protocol and the one or more subsequent CASs may be multiplexed with communications associated with the second broadcast communication protocol in accordance with the modification.

In some examples of the method, apparatuses, and non-transitory computer-readable medium described herein, the CAS includes an indication that the time or frequency resources allocated for the CAS in accordance with the first broadcast communication protocol may be multiplexed, shared, or overlapped with the time or frequency resources allocated in accordance with the second broadcast communication protocol.

Some examples of the method, apparatuses, and non-transitory computer-readable medium described herein may further include operations, features, means, or instructions for transmitting, to a second network node capable of broadcasting in accordance with the first broadcast communication protocol, an indication of the modification for use, by the second network node, in transmission of additional CASs in accordance with the first broadcast communication protocol.

Some examples of the method, apparatuses, and non-transitory computer-readable medium described herein may further include operations, features, means, or instructions for applying a scrambling sequence to the CAS, where the scrambling sequence may be associated with time or frequency resources allocated for the CAS in accordance with the first broadcast communication protocol being multiplexed, shared or overlapped with time or frequency resources allocated in accordance with a second broadcast communication protocol.

In some examples of the method, apparatuses, and non-transitory computer-readable medium described herein, the CAS indicates the modification to the transmission of the one or more subsequent CASs in accordance with the first broadcast communication protocol via a SIB in the CAS.

A method for wireless communications at a first network node is described. The method may include receiving a CAS in accordance with a first broadcast communication protocol, where the CAS indicates a modification to transmission of one or more subsequent CASs in accordance with the first broadcast communication protocol, decoding the CAS indicting the modification to transmission of the one or more subsequent CASs in accordance with the first broadcast communication protocol, and receiving the one or more subsequent CASs in accordance with the first broadcast communication protocol and based on the decoded CAS.

An apparatus for wireless communications at a first network node is described. The apparatus may include a processor, memory coupled with the processor, and instructions stored in the memory. The instructions may be executable by the processor to cause the apparatus to receive a CAS in accordance with a first broadcast communication protocol, where the CAS indicates a modification to transmission of one or more subsequent CASs in accordance with the first broadcast communication protocol, decode the CAS indicting the modification to transmission of the one or more subsequent CASs in accordance with the first broadcast communication protocol, and receive the one or more subsequent CASs in accordance with the first broadcast communication protocol and based on the decoded CAS.

Another apparatus for wireless communications at a first network node is described. The apparatus may include means for receiving a CAS in accordance with a first broadcast communication protocol, where the CAS indicates a modification to transmission of one or more subsequent CASs in accordance with the first broadcast communication protocol, means for decoding the CAS indicting the modification to transmission of the one or more subsequent CASs in accordance with the first broadcast communication protocol, and means for receiving the one or more subsequent CASs in accordance with the first broadcast communication protocol and based on the decoded CAS.

A non-transitory computer-readable medium storing code for wireless communications at a first network node is described. The code may include instructions executable by a processor to receive a CAS in accordance with a first broadcast communication protocol, where the CAS indicates a modification to transmission of one or more subsequent CASs in accordance with the first broadcast communication protocol, decode the CAS indicting the modification to transmission of the one or more subsequent CASs in accordance with the first broadcast communication protocol, and receive the one or more subsequent CASs in accordance with the first broadcast communication protocol and based on the decoded CAS.

In some examples of the method, apparatuses, and non-transitory computer-readable medium described herein, receiving the one or more subsequent CASs may include operations, features, means, or instructions for receiving the one or more subsequent CASs in accordance with a muting pattern, where the modification may be the muting pattern, and where the muting pattern indicates cancelation of transmission of scheduled CASs during one or more sets of time resources.

Some examples of the method, apparatuses, and non-transitory computer-readable medium described herein may further include operations, features, means, or instructions for refraining from monitoring for any communications in accordance with the first broadcast communication protocol during the one or more sets of time resources in accordance with the muting pattern.

Some examples of the method, apparatuses, and non-transitory computer-readable medium described herein may further include operations, features, means, or instructions for receiving one or more data messages in accordance with the first broadcast communication protocol during the one or more sets of time resources in accordance with the muting pattern.

Some examples of the method, apparatuses, and non-transitory computer-readable medium described herein may further include operations, features, means, or instructions for receiving, outside of the one or more sets of time resources, one or more MCCH messages or one or more MSI messages scheduling the one or more data messages in accordance with the first broadcast communication protocol during the one or more sets of time resource.

In some examples of the method, apparatuses, and non-transitory computer-readable medium described herein, the CAS includes a bitmap that indicates the muting pattern.

In some examples of the method, apparatuses, and non-transitory computer-readable medium described herein, receiving the CAS that indicates the modification to the transmission of the one or more subsequent CASs may include operations, features, means, or instructions for receiving an indication of the muting pattern from a set of muting patterns, where set of muting patterns may be associated with a configuration of the first network node.

In some examples of the method, apparatuses, and non-transitory computer-readable medium described herein, receiving the one or more subsequent CASs may include operations, features, means, or instructions for receiving the one or more subsequent CASs in accordance with a periodicity, where the modification may be the periodicity.

In some examples of the method, apparatuses, and non-transitory computer-readable medium described herein, receiving the one or more subsequent CASs may include operations, features, means, or instructions for receiving one or more MCCH messages associated with the one or more subsequent CASs in accordance with one or more starting locations, one or more offsets, or one or more modification duration periods, where the modification further indicates the one or more starting locations, the one or more offsets, or the one or more modification duration periods.

In some examples of the method, apparatuses, and non-transitory computer-readable medium described herein, the CAS that indicates the modification to the transmission of the one or more subsequent CASs in accordance with the first broadcast communication protocol may be an anchor CAS.

Some examples of the method, apparatuses, and non-transitory computer-readable medium described herein may further include operations, features, means, or instructions for receiving an indication of the anchor CAS.

In some examples of the method, apparatuses, and non-transitory computer-readable medium described herein, the anchor CAS may be based on a configuration of the first network node.

In some examples of the method, apparatuses, and non-transitory computer-readable medium described herein, the one or more subsequent CASs may be indicated via the anchor CAS.

In some examples of the method, apparatuses, and non-transitory computer-readable medium described herein, the one or more subsequent CASs may be associated with the anchor CAS.

Some examples of the method, apparatuses, and non-transitory computer-readable medium described herein may further include operations, features, means, or instructions for receiving a MIB during a TTI, where a duration of the TTI may be based on the periodicity.

Some examples of the method, apparatuses, and non-transitory computer-readable medium described herein may further include operations, features, means, or instructions for determining the modified periodicity based on testing a set of multiple candidate periodicities, where testing a candidate periodicity from the set of multiple candidate periodicities includes combining a set of CASs associated with the candidate periodicity.

In some examples of the method, apparatuses, and non-transitory computer-readable medium described herein, time or frequency resources allocated in accordance with the first broadcast communication protocol may be multiplexed, shared, or overlapped with time or frequency resources allocated in accordance with a second broadcast communication protocol and the one or more subsequent CASs may be multiplexed with communications associated with the second broadcast communication protocol in accordance with the modification.

In some examples of the method, apparatuses, and non-transitory computer-readable medium described herein, the CAS includes an indication that the time or frequency resources allocated for the CAS in accordance with the first broadcast communication protocol may be multiplexed, shared, or overlapped with the time or frequency resources allocated in accordance with the second broadcast communication protocol.

In some examples of the method, apparatuses, and non-transitory computer-readable medium described herein, the CAS may be received from a second network node and the method, apparatuses, and non-transitory computer-readable medium may include further operations, features, means, or instructions for receiving, from a third network node, one or more additional CASs in accordance with the modification to transmission of the one or more subsequent CASs in accordance with the first broadcast communication protocol.

In some examples of the method, apparatuses, and non-transitory computer-readable medium described herein, decoding the CAS indicating the modification may include operations, features, means, or instructions for decoding the CAS based on a scrambling sequence, where the scrambling sequence may be associated with time or frequency resources allocated for the CAS in accordance with the first broadcast communication protocol being multiplexed, shared, or overlapped with time or frequency resources allocated in accordance with a second broadcast communication protocol.

In some examples of the method, apparatuses, and non-transitory computer-readable medium described herein, the CAS indicates the modification to the transmission of the one or more subsequent CASs in accordance with the first broadcast communication protocol via a SIB in the CAS.

In some examples of the method, apparatuses, and non-transitory computer-readable medium described herein, the first network node may be operable in accordance with both the first broadcast communication protocol and a second broadcast communication protocol.

In some examples of the method, apparatuses, and non-transitory computer-readable medium described herein, the CAS may be received from a second network node and the method, apparatuses, and non-transitory computer-readable medium may include further operations, features, means, or instructions for receiving, from a third network node, one or more signals in accordance with a second broadcast communication protocol, where a duration between the CAS and the one or more signals may be based on a time threshold.

In some examples of the method, apparatuses, and non-transitory computer-readable medium described herein, the time threshold may be based on a configuration of the first network node.

In some examples of the method, apparatuses, and non-transitory computer-readable medium described herein, the one or more signals indicate a presence or absence of one or more additional CASs communicated in accordance with the first broadcast communication protocol during one or more time resources, one or more frequency resources, or both.

### BRIEF DESCRIPTION OF THE DRAWINGS

FIG. 1 illustrates an example of a wireless communications system that supports coexistence of broadcast communication protocols in accordance with one or more aspects of the present disclosure.

FIG. 2 illustrates an example of a wireless communication that supports coexistence of broadcast communication protocols in accordance with one or more aspects of the present disclosure.

FIG. 3 illustrates examples of timing diagrams that supports coexistence of broadcast communication protocols in accordance with one or more aspects of the present disclosure.

FIG. 4 illustrates examples of timing diagrams that supports coexistence of broadcast communication protocols in accordance with one or more aspects of the present disclosure.

FIG. 5 illustrates examples of timing diagrams that supports coexistence of broadcast communication protocols in accordance with one or more aspects of the present disclosure.

FIG. 6 illustrates an example of a process flow that supports coexistence of broadcast communication protocols in accordance with one or more aspects of the present disclosure.

FIGS. 7 and 8 illustrate block diagrams of devices that support coexistence of broadcast communication protocols in accordance with one or more aspects of the present disclosure.

FIG. 9 illustrates a block diagram of a communications manager that supports coexistence of broadcast communication protocols in accordance with one or more aspects of the present disclosure.

FIG. 10 illustrates a diagram of a system including a device that supports coexistence of broadcast communication protocols in accordance with one or more aspects of the present disclosure.

FIGS. 11 and 12 illustrate block diagrams of devices that support coexistence of broadcast communication protocols in accordance with one or more aspects of the present disclosure.

FIG. 13 illustrates a block diagram of a communications manager that supports coexistence of broadcast communication protocols in accordance with one or more aspects of the present disclosure.

FIG. 14 illustrates a diagram of a system including a device that supports coexistence of broadcast communication protocols in accordance with one or more aspects of the present disclosure.

FIGS. 15 and 16 illustrate flowcharts showing methods that support coexistence of broadcast communication protocols in accordance with one or more aspects of the present disclosure.

### DETAILED DESCRIPTION

Some wireless communications systems may support broadcast communications in which a network entity may broadcast signaling according to a broadcast communication protocol. For example, a first network entity may broadcast communications in accordance with a first broadcast communication protocol (e.g., 5G broadcasting) and a second network entity may broadcast communications in accordance with a second broadcast communication protocol (e.g., Advanced Television Standards Committee (ATSC) 3.0 broadcasting). In such cases, the first broadcast communication protocol may be associated with a set of frequency resources that overlaps with frequency resources associated with the second broadcast communication protocol. In some cases, the second network entity may refrain from broadcasting (e.g., pause broadcasting of) communications in accordance with the second broadcast communication protocol on one or more occasions, such that the first network entity may broadcast communications in accordance with the first broadcast communication protocol during the one or more occasions (e.g., the paused occasions). However, in some cases, the first network entity may broadcast one or more signals in accordance with the first broadcast communication protocol (e.g., cell acquisition subframes (CASs), multicast control channel (MCCH) messages, and multicast scheduling information (MSI)) continuously. That is, the one or more signals may be considered “always on,” such that the first network entity may broadcast the one or more signals according to a fixed periodicity (e.g., without any paused occasions). In such cases, communications broadcast by the second network entity in accordance with the second broadcast communication protocol may interfere with the one or more “always on” signals broadcast by the first network entity.

Accordingly, techniques described herein may support methods for coexistence of broadcasting communication protocols to reduce interference. For example, a network entity may broadcast a CAS in accordance with the first broadcast communication protocol, where frequency resources allocated in accordance with the first broadcast communication protocol overlap with frequency resources allocated in accordance with a second broadcast communication protocol. In such cases, the CAS may indicate a modification to transmission of one or more subsequent CASs in accordance with the first broadcast communication protocol. In some examples, the modification may be a muting pattern that cancels transmission of scheduled CASs during one or more sets of time resources. Additionally, or alternatively, the modification may be a periodicity that modifies a duration between the scheduled CAS broadcasts. As such, the network entity may transmit, in accordance with the first broadcast communication protocol, the one or more subsequent CASs in accordance with the modification. In such cases, the one or more subsequent CASs may be time division multiplexed (TDMed) with communications broadcast in accordance with the second broadcast communication protocol.

Aspects of the disclosure are initially described in the context of wireless communications systems. Aspects are then described in the context of timing diagrams and a process flow. Aspects of the disclosure are further illustrated by and described with reference to apparatus diagrams, system diagrams, and flowcharts that relate to coexistence of broadcast communication protocols

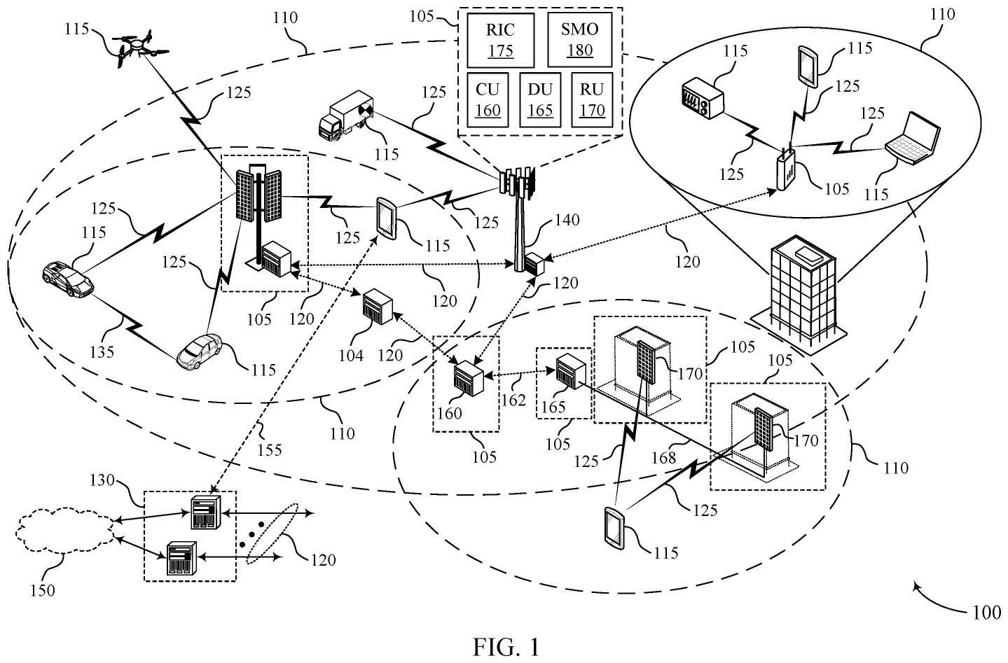

FIG. 1 illustrates an example of a wireless communications system 100 that supports coexistence of broadcast communication protocols in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c. F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support coexistence of broadcast communication protocols as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may support methods for coexistence of broadcasting communication protocols to reduce interference. For example, a network entity 105 may broadcast a CAS in accordance with the first broadcast communication protocol, where frequency resources allocated in accordance with the first broadcast communication protocol overlap with frequency resources allocated in accordance with a second broadcast communication protocol. In such cases, the CAS may indicate a modification to transmission of one or more subsequent CASs in accordance with the first broadcast communication protocol. In some examples, the modification may be a muting pattern that cancels transmission of scheduled CASs during one or more sets of time resources. Additionally, or alternatively, the modification may be a periodicity that modifies a duration between the scheduled CAS broadcasts. As such, the network entity 105 may transmit, in accordance with the first broadcast communication protocol, the one or more subsequent CASs in accordance with the modification. In such cases, the one or more subsequent CASs may be time division multiplexed (TDMed) with communications broadcast in accordance with the second broadcast communication protocol.

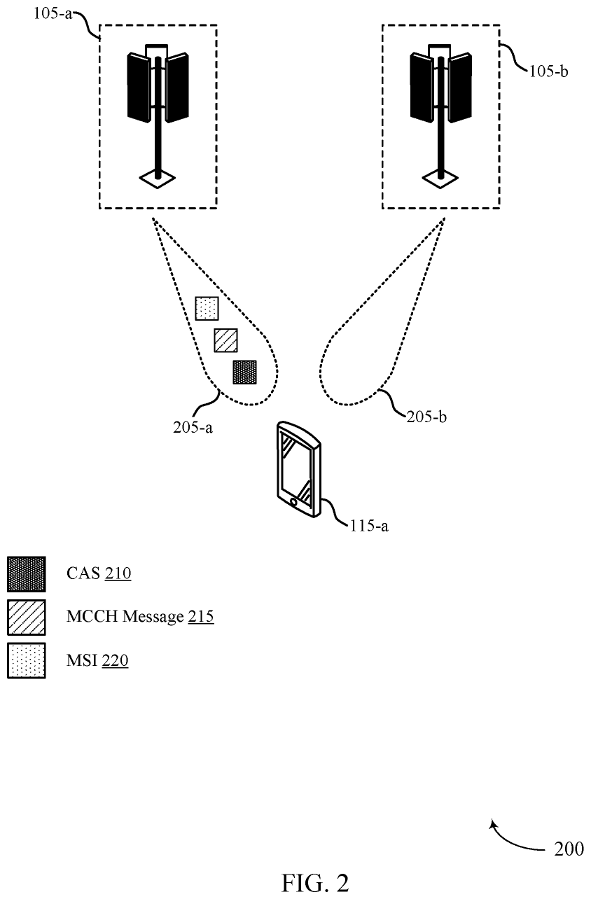

FIG. 2 illustrates an example of a wireless communications system 200 that supports coexistence of broadcast communication protocols in accordance with one or more aspects of the present disclosure. In some examples, the wireless communications system 200 may implement or be implemented by aspects of the wireless communications system 100. For example, the wireless communications system 200 may include on or more network entities 105 (e.g., network entity 105-a and network entity 105-b) and one or more UEs 115 (e.g., UE 115-a), which may be examples of the corresponding devices as described with reference to FIG. 1. In some examples, a network entity 105-a and a network entity 105-b may be a same network entity 105. The wireless communications system 200 may include features for multiplexing communications associated with a first broadcast communication protocol (e.g., 5G broadcasting) with communications associated with a second broadcast communication protocol (e.g., ATSC 3.0 broadcasting), as described herein.

Some wireless communication systems may support broadcast communications in which a network entity 105 may broadcast signaling according to a broadcast communication protocol 205. That is, the network entity 105 may be associated with a broadcast communication system (e.g., including at least a broadcasting device, such as the network entity 105) in which the network entity 105 broadcasts signaling according to the broadcast communication protocol 205 associated with the broadcast communication system. For example, a first network entity 105, such as a network entity 105-a, may broadcast signaling in accordance with (e.g., according to) to a broadcast communication protocol 205-a (e.g., 5G broadcasting) and a second network entity 105, such as a network entity 105-b, may broadcast in accordance with a broadcast communication protocol 205-b (e.g., ATSC 3.0 broadcasting). In such cases, the network entity 105-a may be associated with (e.g., part of) a first broadcast communication system (e.g., associated with 5G broadcasting) and the network entity 105-b may be associated with a second broadcast communication system (e.g., associated with ATSC 3.0 broadcasting). In some examples, a UE 115-a may be associated with (e.g., part of) the first broadcast communication system, the second broadcast communication system, or both.

Additionally, the broadcast communication protocol 205-a may be associated with a set of frequency resources that overlaps with frequency resources associated with the broadcast communication protocol 205-b. In such cases, the network entity 105-b may refrain from (e.g., pause, mute) broadcasting communications in accordance with the broadcast communication protocol 205-b during one or more sets of time resources (e.g., complete holes for periods of time). That is, the network entity 105 may pause broadcasting communications in accordance with (e.g., associated with) the broadcast communication protocol 205-b during one or more sets of time resources (e.g., and frequency resources) such that the network entity 105-a may broadcast communications in accordance with the broadcast communication protocol 205-a during one or more sets of time resources without interference from the communications associated with the broadcast communication protocol 205-b.

However, in some cases, the network entity 105-a (e.g., a multimedia broadcast multicast service (MBMS)-dedicated cell) may broadcast one or more “always on” signals in accordance with the broadcast communication protocol 205-a. That is, the network entity 105-a may broadcast the one or more “always on” signals in accordance with the broadcast communication protocol 205-a according to a fixed (e.g., preconfigured) periodicity (e.g., without any paused occasions). For example, the one or more “always on” signals broadcast in accordance with the broadcast communication protocol 205-a may include CASs 210, MCCH messages 215, MSI 220, or any combination thereof.

In other words, the network entity 105-a may transmit a CAS 210 (e.g., SystemInformationBlock13-r9) to a UE 115, such as the UE 115-a, according to a periodicity (e.g., once every 40 ms). The CAS 210 may be associated with a duration (e.g., 1 ms) and may contain one or more messages (e.g., a synchronization signal, physical downlink control channel (PDCCH) messages, and physical downlink shared channel (PDSCH) messages). For example, the CAS 210 may include (e.g., contain) a PDSCH message, which may further include a system information block (SIB) indicating one or more multimedia broadcast single frequency network (MBSFN) areas (e.g., MBSFN-AreaInfoList-r9) associated with the network entity 105-a (e.g., present in a cell). Additionally, or alternatively, the SIB may indicate one or more MCCH configuration (e.g., mcch-Config-r9, mcch-Config-r-14) associated with each of the one or more MBSFN areas. The one or more MCCH configurations may configure the UE 115-a to receive one or more MCCH messages 215 (e.g., MCCH-Message). In other words, the one or more MCCH configurations may indicate a set of resources associated with one or more MCCHs in which the UE 115-a may receive the one or more MCCH messages 215. In some cases, the one or more MCCH messages 215 may include a configuration (e.g., PMCH-Config-r9) associated with (e.g., for) a data channel (e.g., a multicast traffic channel (MTCH) or a physical multicast channel (PMCH)). Additionally, the configuration associated with the data channel may indicate a configuration associated with MSI 220 (e.g., mch-ScheduelingPeriod-r9). In other words, the UE 115-a may receive a data transmission (e.g., an MTCH block) over the data channel (e.g., MTCH) which may include an MSI 220 (e.g., a scheduling MAC-CE provided at lower layers for MBMS user data, which the network entity 105-a may transmit via an MTCH logical channel).

In such cases, the network entity 105-b may be unable to broadcast communications in accordance with the broadcast communication protocol 205-b in the shared set of frequency resources without interference from communications (e.g., CASs 210, MCCH messages 215, MSI 220, or any combination thereof) broadcast in accordance with the broadcast communication protocol 205-a by the network entity 105-a (e.g., 5G broadcast may be unable to co-exist with ATSC 3.0).

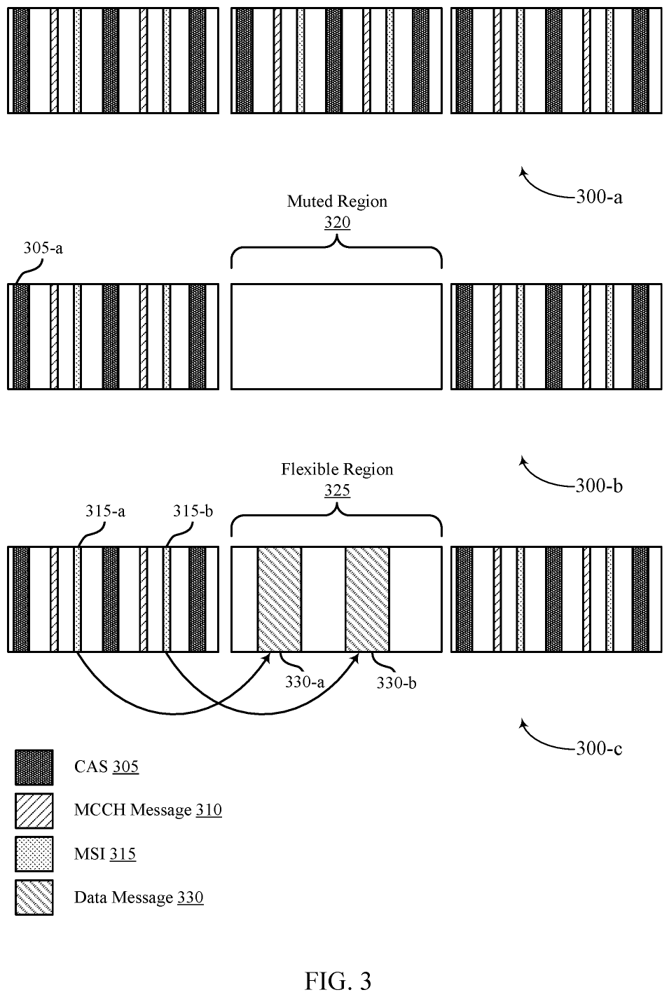

Accordingly, techniques described herein may support methods for co-existence of broadcast communication protocols 205 on a shared set of frequency resources via TDM. For example, as described previously, a network entity 105-a may broadcast communications in accordance with a broadcast communication protocol 205-a on a set of time resources, frequency resources, or both, that are shared, multiplexed, or overlapped, with communications broadcast by a network entity 105-b in accordance with a broadcast communication protocol 205-b. In some cases, the network entity 105-a may mute (e.g., pause) any communications in accordance with the broadcast communication protocol 205-a for one or more periods, which may be referred to as muted regions. That is, the network entity 105-a may refrain from broadcasting any communications in accordance with the broadcast communication protocol 205-a during a set of time resources (e.g., and frequency resources) associated with the one or more muted regions, as described with reference to FIG. 3. In such cases, the one or more muted regions may be associated with a muting pattern and the network entity 105-a may broadcast a CAS 210 (e.g., a periodic control signal that contains system information associated with communications broadcast by the network entity 105-a in accordance with the broadcast communication protocol 205-a) indicating the muting pattern, where the muting pattern cancels transmission of scheduled CASs 210 (e.g., as well as any other communications in accordance with the broadcast communication protocol 205-a) during the one or more muted regions. As such, the network entity 105-b may broadcast communications in accordance with the broadcast communication protocol 205-b during the one or more muted regions.

Additionally, or alternatively, the network entity 105-a may mute (e.g., pause) one or more “always on” signals, such as CAS 210, MCCH messages 215, or MSI 220, for one or more periods, but may schedule (e.g., flexibly) broadcasts of one or more data messages during the one or more periods, which may be referred to as flexible regions, as described with reference to FIG. 3. That is, if the network entity 105-b does not schedule a broadcast of communications in accordance with the broadcast communication protocol 205-b during a flexible region, the network entity 105-a may schedule a broadcast of one or more data messages (e.g., transmissions) in accordance with the broadcast communication protocol 205-a during the flexible region. As described previously, the one or more flexible regions may be associated with a muting pattern and the network entity 105-a may broadcast a CAS 210 (e.g., received by the UE 115-a) indicating the muting pattern, where the muting pattern cancels transmission of scheduled CASs 210 (e.g., as well as MCCH messages 215, MSI 220, or both) during the one or more flexible regions.

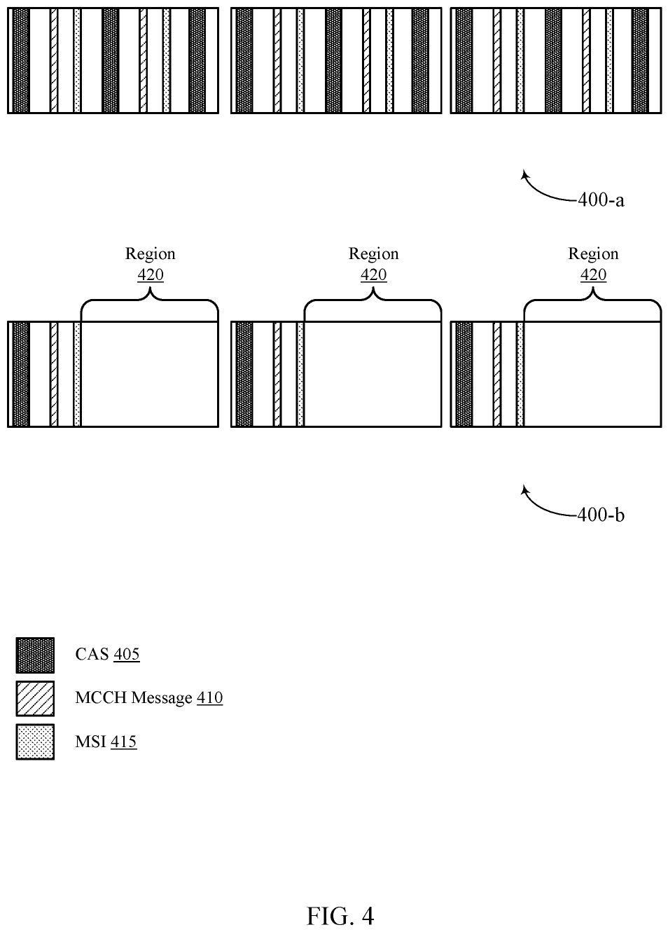

Additionally, or alternatively, the network entity 105-a may increase a duration (e.g., time) between broadcasts of CAS 210. That is, the network entity 105-a may increase a periodicity (e.g., decrease a frequency) at which the network entity 105-a broadcasts CAS 210 (e.g., to beyond 40 ms), such that the network entity 105-b may broadcast communications in accordance with the broadcast communication protocol 205-b between broadcasts of CAS 210, as described with reference to FIG. 4. In such cases, the network entity 105-a may broadcast a CAS 210 (e.g., received by the UE 115-a) indicating the periodicity (e.g., modified periodicity).

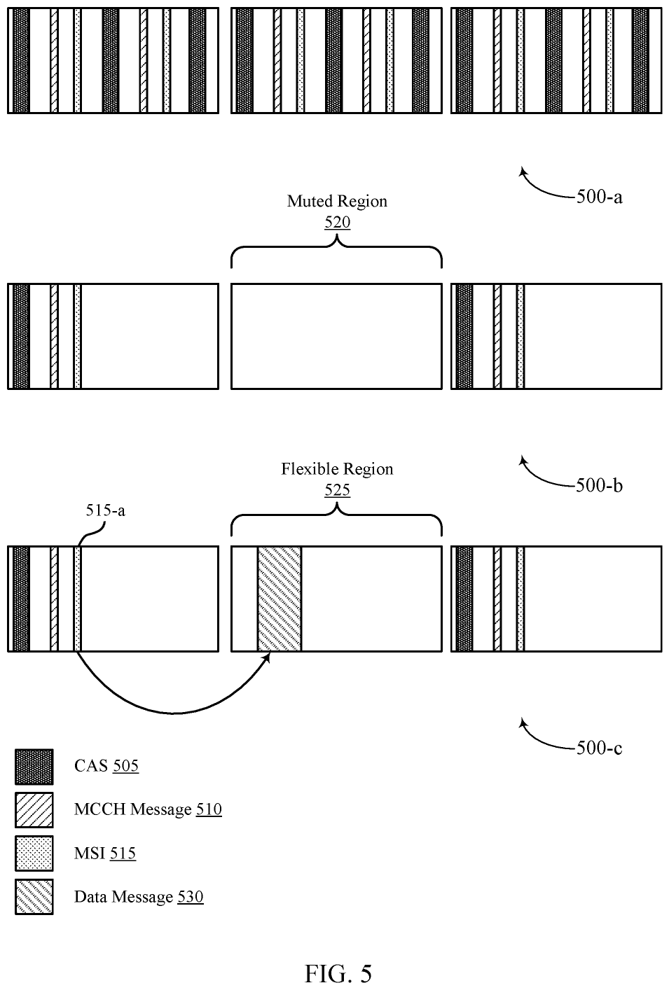

Additionally, or alternatively, the network entity 105-a may use some combination of the techniques described herein. That is, the network entity 105-a may mute all communications in accordance with the broadcast communication protocol 205-a during one or more muted regions, mute CAS 210 during one or more flexible regions, increase the duration between broadcasts of CAS 210, or any combination thereof, as described with reference to FIG. 5.

In some examples, the CAS 210 indicating a modification to transmission of communications associated with the broadcast communication protocol 205-a (e.g., indicating a muting pattern, a periodicity, or both) may be specific to the wireless communications system 200 in which the broadcast communication protocol 205-a and the broadcast communication protocol 205-b co-exist (e.g., a system which includes both 5G broadcasting and ATSC 3.0 broadcasting). For example, the CAS 210 may indicate, to the UE 115-a, existence of the broadcast communication protocol 205-a, the broadcast communication protocol 205-b, or both (e.g., the CAS 210 may indicate the presence of an “ATSC 3.0 bootstrap signal” and/or the location in time of the ATSC 3.0 bootstrap signal). In other words, the CAS 210 may indicate that time resources, frequency resources, or both, allocated in accordance with the broadcast communication protocol 205-a are multiplexed, shared, or overlapped with time resources, frequency resources, or both, allocated in accordance with the broadcast communication protocol 205-b. Accordingly, the CAS 210 may enable the UE 115-a to support (e.g., utilize) both the broadcast communication protocol 205-a and the broadcast communication protocol 205-b (e.g., the UE 115-a may be a “dual-mode” UE 115-a which may switch between a 5G broadcasting service and an ATSC 3.0 service). Additionally, or alternatively, the network entity 105-a may apply a scrambling sequence (e.g., or other modification, such as a modification to a sync signal in the CAS 210) to the CAS 210, where the scrambling sequence is based on co-existence of the broadcast communication protocol 205-a and the broadcast communication protocol 205-b (e.g., which may prevent other UEs 115, such as legacy UEs, from reading the coexistent-specific CAS 210).

Additionally, the UE 115-a may receive communications in accordance with the broadcast communication protocol 205-a and receive communications in accordance with the broadcast communication protocol 205-b based on a time threshold. That is, the UE 115-a may receive a CAS 210 and communications in accordance with the broadcast communication protocol 205-b (e.g., a “bootstrap signal”), where a duration between the CAS 210 and the communications in accordance with the broadcast communication protocol 205-b is based on the time threshold. For example, the UE 115-a may receive a communication in accordance with the broadcast communication protocol 205-b preceding (e.g., immediately preceding) the CAS 210 based on the time threshold. The time threshold may be based on a configuration of the network entity 105-a, a configuration of the UE 115-a, or both (e.g., pre-configured, defined in standards). In some examples, the communication in accordance with the broadcast communication protocol 205-b (e.g., the “bootstrap signal”) may indicate a presence or absence of CAS 210, data messages, or both, associated with the broadcast communication protocol 205-a in a set of time resources, a set of frequency resources, or both (e.g., a given time or frequency region).

Thought described in the context of a first broadcast communication protocol associated with a network entity 105-a and a second broadcast communication protocol associated with a network entity 105-b, this is not to be regarded as a limitation of the present disclosure. In this regard, any quantity of network entities 105 supporting any quantity of broadcast communication protocols may be considered with regards to the techniques described herein. For example, the network entity 105-a and the network entity 105-b may be a same network entity 105, such that the same network entity 105 supports the first broadcast communication protocol and the second broadcast communication protocol.

FIG. 3 illustrates examples of timing diagrams 300 (e.g., a timing diagram 300-a, a timing diagram 300-b, and a timing diagram 300-c) that supports coexistence of broadcast communication protocols in accordance with one or more aspects of the present disclosure. In some examples, the timing diagrams 300 may implement or be implemented by aspects of the wireless communications system 100 or the wireless communications system 200. For example, the timing diagrams 300 may be implemented by one or more network entities 105 and one or more UEs 115, which may be examples of the corresponding devices as described with reference to FIG. 1. The timing diagrams 300 may include features for multiplexing communications associated with a first broadcast communication protocol (e.g., 5G broadcasting) with communications associated with a second broadcast communication protocol (e.g., ATSC 3.0 broadcasting), as described herein.

In some examples, as described with reference to timing diagram 300-a, a first network entity 105 may broadcast, in accordance with a first broadcast communication protocol (e.g., 5G broadcasting), communications, such as CAS 305, MCCH message 310, and MSI 315, according to a fixed periodicity (e.g., every 40 ms). That is, CAS 305, MCCH message 310, and MSI 315 may be considered signals which are “always on” such that the first network entity 105 transmits the CAS 305, the MCCH message 310, and the MSI 315 without muted regions 320 or flexible regions 325, as described with reference to FIG. 2.

In some implementations, as described with reference to timing diagram 300-b, the first network entity 105 may mute broadcasting of communications (e.g., signaling) in accordance with the first broadcast communication protocol for one or more periods (e.g., sets of time resources), which may be referred to as muted regions 320. That is, during the muted region 320, the first network entity 105 may refrain from broadcasting any communications in accordance with the first broadcast communication protocol, including CAS 305, MCCH messages 310, and the MSI 315. Additionally, a UE 115 may refrain from monitoring for any communications in accordance with the first broadcast communication protocol, including CAS 305, MCCH messages 310, and the MSI 315 during the muted region 320. As such, a second network entity 105 may broadcast communications in accordance with a different (e.g., second) broadcast communication protocol (e.g., ATSC 3.0 broadcasting) during the muted region 320, without interference from communications broadcast, by the first network entity 105, in accordance with the first broadcast communication protocol.

Additionally, or alternatively, as described with reference to timing diagram 300-c, the first network entity 105 may mute broadcasting of CAS 305, MCCH messages 310, MSI 315, or any combination thereof (e.g., “always on” signals), for one or more periods (e.g., sets of time resources) without muting broadcasts of other types of communications (e.g., data messages 330) in accordance with the first broadcast communication protocol during the one or more periods, which may be referred to as flexible regions 325. That is, the first network entity 105 may refrain from broadcasting CAS 305, MCCH messages 310, MSI 315, or any combination thereof, during the flexible region 325. Additionally, a UE 115 may refrain from monitoring for CAS 305, MCCH messages 310, MSI 315, or any combination thereof, during the flexible region 325. As such, the second network entity 105 may broadcast communications in accordance with a different broadcast communication protocol (e.g., ATSC 3.0 broadcasting) during the flexible region 325, without interference from the CAS 305, the MCCH messages 310, the MSI 315, or any combination thereof, broadcast by the first network entity 105, in accordance with the first broadcast communication protocol. However (e.g., if the second network entity 105 is not broadcasting communications in accordance with the different broadcast communication protocol during the flexible region 325), the first network entity 105 may broadcast one or more data messages 330 in the flexible region 325 (e.g., scheduled by one or more MCCH messages 310, one or more MSI 315, or both). That is, the first network entity may broadcast an MSI 315-a and an MSI 315-b during a non-muted region (e.g., a region in which the CAS 305, the MCCH messages 310, and the MSI 315 are not muted) and the MSI 315-a and the MSI 315-b may schedule a data message 330-a and data message 330-b, respectively, during the flexible region 325.

In some cases, a UE 115 may be unable to process a data message 330 during a flexible regions 325. In such cases, a SIB may be fixed (e.g., unable to change) during the flexible regions 325. The UE 115 may indicate a capability to process data messages 330 during flexible regions 325 in UE capability information. In other words, the UE 115 may transmit a capability message indicating the capability of the UE 115 to process data messages 330 during flexible regions 325.

In some examples, a CAS 305, such as the CAS 305-a, may indicate a configuration (e.g., muting configuration) associated with one or more muted regions 320, one or more flexible regions 325, or both, which may be referred to as a muting pattern. That is, the CAS 305-a may include system information (e.g., a SIB) indicating the muting pattern. For example, the muting pattern may a frequency (e.g., one or more frequency resources), a duration (e.g., one or more time resources), or both, of the one or more muted regions 320, the one or more flexible regions 325, or both.

In some examples, the first network entity 105 may modify a muting pattern (e.g., configuration) via a SIB change notification (e.g., by triggering a SIB change notification). In some examples, the first network entity 105 may indicate the muting pattern via a bitmap in a SIB, may indicate the muting pattern from a set of muting patterns (e.g., from a set of pre-specified configurations), or both. That is, the first network entity 105 may broadcast the set of muting patterns (e.g., configure a UE 115 with the set of configurations) and may broadcast a CAS 305 indicating a selected muting pattern from the set of muting patterns. Additionally, or alternatively, the set of muting patterns may be based on a configuration of the first network entity 105, a configuration of the UE 115, or both (e.g., pre-configured). For example, in the timing diagram 300-b, the first network entity 105 may broadcast the CAS 305-a indicating a bitmap associated with the muted region 320 or indicating a selected muting pattern (e.g., from the set of muting patterns) associated with the muted region 320.

In some examples, a muting pattern may include (e.g., indicate) a duration (e.g., a minimum quantity of frames) during which the muting pattern n may be applied by the first network entity 105 (e.g., a minimum validity period). In some cases (e.g., in single frequency networks), the first network entity 105 may transmit, to one or more other network entities 105 (e.g., capable of broadcasting in accordance with the first broadcast communication protocol), an indication of a muting pattern (e.g., in the same single frequency network), such that the first network entity 105 and the one or more other network entities 105 broadcast according to the same muting pattern. In some examples, the first network entity 105 and the one or more other network entities 105 may be a part of a same single frequency network, may be associated with a same set of network entities 105 (e.g., neighbor cells in a neighbor cell list), or both. In other words, the UE 115 may assume that CASs 305 received from network entities 105 associated with a same single frequency network, a same set of network entities 105, or both, may use a same (e.g., identical) muting pattern.

FIG. 4 illustrates examples of timing diagrams 400 that supports coexistence of broadcast communication protocols in accordance with one or more aspects of the present disclosure. (e.g., a timing diagram 400-a, and a timing diagram 400-b) that supports coexistence of broadcast communication protocols in accordance with one or more aspects of the present disclosure. In some examples, the timing diagrams 400 may implement or be implemented by aspects of the wireless communications system 100, the wireless communications system 200, and the timing diagrams 300. For example, the timing diagrams 400 may be implemented by one or more network entities 105 and one or more UEs 115, which may be examples of the corresponding devices as described with reference to FIG. 1. The timing diagrams 400 may include features for multiplexing communications associated with a first broadcast communication protocol (e.g., 5G broadcasting) with communications associated with a second broadcast communication protocol (e.g., ATSC 3.0 broadcasting), as described herein.

In some examples, as described with reference to timing diagram 400-a, a first network entity 105 may broadcast, in accordance with a first broadcast communication protocol (e.g., 5G broadcasting), communications, such as CAS 405, MCCH messages 410, and MSI 415, according to a fixed periodicity (e.g., every 40 ms). That is, CAS 405, MCCH messages 410, and MSI 415 may be considered signals which are “always on” such that the first network entity 105 transmits the CAS 405, the MCCH messages 410, and the MSI 415 without muted regions or flexible regions, as described with reference to FIG. 3.

In some examples, as described with reference to timing diagram 400-b, the first network entity 105 may modify a periodicity (e.g., starting location, offset, periodicity) of CAS 405, MCCH messages 410, MSI 415, or any combination thereof. That is, the first network entity 105 may broadcast the CAS 405, the MCCH message 410, the MSI 415, or any combination thereof, according to an increased periodicity (e.g., less frequently). For example, the first network entity 105 may increase a periodicity of the CAS 405 (e.g., to beyond 40 ms). Additionally, or alternatively, the first network entity 105 may modify (e.g., adjust) an MCCH configuration (e.g., location, periodicity, offset, modification period) associated with MCCH messages 410 such that the MCCH messages 410 may be sparser (e.g., as compared to broadcast of MCCH messages 410 prior to modification). Additionally, or alternatively, the first network entity 105 may modify an MSI configuration associated with MSI 415 to increase a periodicity of the MSI 415 (e.g., to make broadcasts of the MSI 415 sparser as compared to broadcast of MSI 415 prior to modification). As such, a second network entity 105 may broadcast communications in accordance with a second (e.g., different) broadcast communication protocol (e.g., ATSC 3.0 broadcasting) during regions 420 (e.g., without CAS 405, the MCCH messages 410, the MSI 415), where the regions 420 are based on the increased periodicity.

In some examples, the first network entity 105 may modify the periodicity of the CAS 405, the MCCH messages 410, the MSI 415, or any combination thereof, such that the regions 420 may be the same duration (e.g., approximately the same duration) as the communications broadcast in accordance with the second broadcast communication protocol (e.g., such that there is no “wasted space” between the broadcasts). Additionally, or alternatively, the first network entity 105 may increase (e.g., extend) a duration of one or more transmission time intervals (TTIs) for master information blocks (MIBs) carrying the CAS 405, the MCCH messages 410, and the MSI 415. That is, the first network entity 105 may extend the TTI (e.g., from 160 ms containing four 40 ms periods) to a longer interval (e.g., for cross-CAS 405 combining).

In some implementations (e.g., when the first broadcast communication protocol co-exists with the second broadcast communication protocol), the first network entity may broadcast different CASs 405 at different periodicities (e.g., every 40 ms, 60 ms, and 80 ms). Additionally, a UE 115 may combine multiple CASs 405 from a set of CASs 405. In such implementations, the UE 115 may determine (e.g., hypothesize) a periodicity (e.g., by testing multiple periodicities) associated with a set of CASs 405 to determine which CASs 405 (e.g., from the different CASs 405) the UE 115 may be able to combine. For example, the UE 115 may determine a modified periodicity (e.g., indicated via a CAS) based on testing multiple candidate periodicities, where testing a candidate periodicity form the multiple candidate periodicities includes combining a set of CASs associated with the candidate periodicity. In such cases, the UE 115 may determine the candidate periodicity is the modified periodicity based on successfully combining the set of CASs.

Additionally, or alternatively, the CAS that indicates the periodicity (e.g., modification to the transmission of one or more subsequent CASs) may be an anchor CAS 405. In some examples, the first network entity 105 may broadcast an indication of an anchor CAS 405. In some other examples, the anchor CAS 405 may be based on a configuration of the first network entity 105, a configuration of the UE 115, or both. The anchor CAS 405 may be associated with a fixed (e.g., always on), sparse periodicity (e.g., as compared to other CASs 405).

In some examples, the UE 115 may receive the anchor CAS 405 to obtain information associated with additional CASs 405 (e.g., that may be present in the MBMS-dedicated cell). That is, the periodicity indicated via the anchor CAS 405 may be associated with additional CASs 405 indicated via the anchor CAS 405. Accordingly, the UE 115 may determine which CAS 405 to combine based on the information associated with the additional CASs 405. Additionally, or alternatively, the UE 115 may receive the anchor CAS 405 to obtain information associated with additional CASs 405 (e.g., additional CAS 405 transmissions associated with the anchor CAS 405). That is, the periodicity indicated via the anchor CAS 405 may be associated with additional CAS 405 transmissions associated with anchor CASs 405. In such cases, a duration of a TTI associated with a MIB further associated with the anchor CAS 405 may be modified based on the information associated with additional anchor CASs 405.

FIG. 5 illustrates examples of timing diagrams 500 that supports coexistence of broadcast communication protocols in accordance with one or more aspects of the present disclosure. (e.g., a timing diagram 500-a, a timing diagram 500-b, and a timing diagram 500-c) that supports coexistence of broadcast communication protocols in accordance with one or more aspects of the present disclosure. In some examples, the timing diagrams 500 may implement or be implemented by aspects of the wireless communications system 100, the wireless communications system 200, the timing diagrams 300, and the timing diagrams 400. For example, the timing diagrams 500 may be implemented by one or more network entities 105 and one or more UEs 115, which may be examples of the corresponding devices as described with reference to FIG. 1. The timing diagrams 500 may include features for multiplexing communications associated with a first broadcast communication protocol (e.g., 5G broadcasting) with communications associated with a second broadcast communication protocol (e.g., ATSC 3.0 broadcasting), as described herein.

In some examples, as described with reference to timing diagram 500-a, a first network entity 105 may broadcast, in accordance with a first broadcast communication protocol (e.g., 5G broadcasting), communications, such as CAS 505, MCCH messages 510, and MSI 515, according to a fixed periodicity (e.g., every 40 ms). That is, CAS 505, MCCH messages 510, and MSI 515 may be considered signals which are “always on” such that the first network entity 105 transmits the CAS 505, the MCCH messages 510, and the MSI 515 without muted regions 520 or flexible regions 525.

In some examples, the first network entity 105 may broadcast communications in accordance with a first broadcast communication protocol according to an increased periodicity and with muted regions 520 or flexible regions 525. That is, the first network entity 105 may broadcast CAS 505, MCCH messages 510, and MSI 515 according to an increased periodicity (e.g., less frequently) such that a second network entity 105 may broadcast communications in accordance with a second broadcast communication protocol (e.g., ATSC 3.0 broadcasting) between broadcasts of the CAS 505, the MCCH message 510, and the MSI 515, as described with reference to FIG. 4. Additionally, the first network entity 105 may pause broadcasting of all communications in accordance with the first broadcast communication protocol during one or muted regions 320, as described with reference to timing diagram 500-a, such that the second network entity 105 may broadcast communications in accordance with a second broadcast communication protocol (e.g., ATSC 3.0 broadcasting) during the one or more muted regions 320, as described with reference to FIG. 3

Additionally, or alternatively, the first network entity 105 may pause broadcasting of CAS 505, MCCH messages 510, and MSI 515 during one or more flexible regions 525, as described with reference to timing diagram 500-a, such that the second network entity 105 may broadcast communications in accordance with a second broadcast communication protocol (e.g., ATSC 3.0 broadcasting) during the one or more flexible regions 525, as described with reference to FIG. 3. In some examples, the first network entity 105 may broadcast one or more data messages 530 (e.g., scheduled by an MSI 515-a) during the flexible region 525.

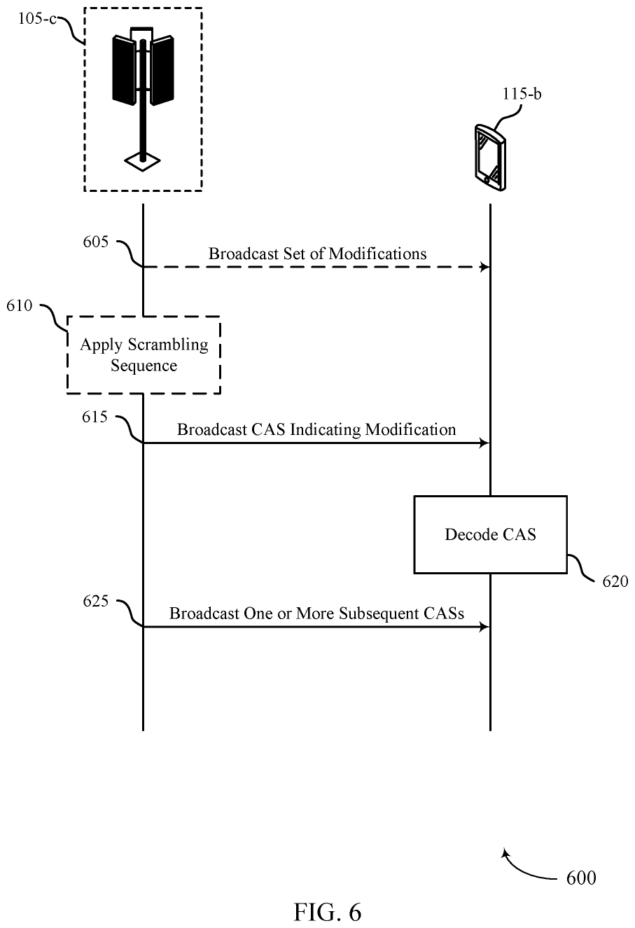

FIG. 6 illustrates an example of a process flow 600 that supports coexistence of broadcast communication protocols in accordance with one or more aspects of the present disclosure. In some examples, the process flow 600 may implement or be implemented by aspects of the wireless communications system 100, the wireless communications system 200, the timing diagrams 300, the timing diagrams 400, and the timing diagrams 500. For example, the process flow 600 may include one or more network entities 105 (e.g., a network entity 105-c) and one or more UEs 115 (e.g., a UE 115-b), which may be examples of the corresponding devices as described with reference to FIG. 1. The timing diagrams 400 may include features for multiplexing communications associated with a first broadcast communication protocol (e.g., 5G broadcasting) with communications associated with a second broadcast communication protocol (e.g., ATSC 3.0 broadcasting), as described herein.

In some examples, at 605, a network entity 105-c (e.g., a first network node) may broadcast, in accordance with the first broadcast communication protocol, an indication of a set of modifications to transmission of one or more CASs. Time resource, frequency resources, or both, allocated in accordance with (e.g., associated with) the first broadcast communication protocol may be multiplexed, shared, or overlapped with time resources, frequency resources, or both, allocated in accordance with a second broadcast communication protocol.

In some examples, at 610, the network entity 105-c may apply a scrambling sequence to the CAS. The scrambling sequence may be associated with the time resources, the frequency resources, or both, allocated in accordance with the first broadcast communication protocol being multiplexed, shared, or overlapped with the time resources, the frequency resources, or both, allocated in accordance with the second broadcast communication protocol. That is, the scrambling sequence may be associated with co-existence of the first broadcast communication protocol with the second broadcast communication protocol.

At 615, the network entity 105-c may broadcast a CAS in accordance with the first broadcast communication protocol, wherein the CAS indicates a modification to transmission of one or more subsequent CASs in accordance with the first broadcast communication protocol. In some examples, the CAS may indicate the modification to the transmission of the one or more subsequent CASs in accordance with the first broadcast communication protocol via a SIB in the CAS.

In some examples, the CAS may include a bitmap that indicates the modification to the transmission of the one or more subsequent CAS in accordance with the first broadcast communication protocol. Alternatively, the modification to the transmission of the one or more subsequent CASs in accordance with the first broadcast communication protocol may be one of a set of modifications. That is, the set of modifications may be based on a configuration of the network entity 105-c, a configuration of the UE 115-b, or both (e.g., the network entity 105-c, the UE 115-b, or both, may be configured with the set of modifications).

In some examples, the CAS may include an indication that the time resources, the frequency resources, or both, allocated in accordance with the first broadcast communication protocol may be multiplexed, shared, or overlapped with the time resources, the frequency resources, or both, allocated in accordance with the second broadcast communication protocol.

In some examples, the CAS that indicates the modification to the transmission of the one or more subsequent CASs in accordance with the first broadcast communication protocol may be the anchor CAS. That is, the network entity 105-c may broadcast an indication of the anchor CAS, where the CAS that indicates the modification to the transmission of the one or more subsequent CASs in accordance with the first broadcast communication protocol is the anchor CAS. In some other examples, the anchor CAS may be based on a configuration of the network entity 105-c, a configuration of the UE 115-b, or both (e.g., the network entity 105-c, the UE 115-b, or both, may be configured with the anchor CAS). In some examples, the one or more subsequent CASs may be indicated via the anchor CAS. Additionally, or alternatively, the one or more subsequent CASs may be associated with the anchor CAS (e.g., may be additional CAS transmissions of the anchor CAS).

In some examples, the network entity 105-c may broadcast, to one or more other network entity 105 capable of broadcasting in accordance with the first broadcast communication protocol, an indication of the modification for use, by the one or more other network entities, in transmission of additional CASs in accordance with the first broadcast communication protocol. That is, the UE 115-b may receive, from an additional network entity 105 in accordance with the first broadcast communication protocol, one or more additional CAS in accordance with the modification to transmission of the one or more subsequent CASs. That is, the network entity 105-c and the additional network entity 105 may be associated with a same single frequency network, a same set of network entities 105, or both.

At 620, a UE 115-b (e.g., a second network node) may decode the CAS indicating the modification to transmission of the one or more subsequent CAS. In some examples, the UE 115-b may be operable in accordance with both the first broadcast communication protocol and the second broadcast communication protocol.

At 625, the network entity 105-c may broadcast, in accordance with the first broadcast communication protocol, the one or more subsequent CASs, where the one or more subsequent CASs are TDMed with communications associated with the second broadcast communication protocol in accordance with the modification. That is, the UE 115-b may receive the one or more subsequent CASs in accordance with the first broadcast communication protocol and based on the decoded CAS.

In some examples, the modification may be a muting pattern (e.g., associated with one or more muted regions, one or more flexible regions, or both) that cancels transmission of scheduled CASs during one or more sets of time resources. In such cases, the network entity 105-c may broadcast the one or more subsequent CASs in accordance with the muting pattern.

For example, the muting pattern may be associated with one or more muted regions, where the one or more muted regions are associated with the one or more sets of time resources. In such cases, the network entity 105-c may refrain from transmission of (e.g., refrain from broadcasting) any communications in accordance with the first broadcast communication protocol during the one or more sets of time resources in accordance (e.g., based on) with the muting pattern (e.g., associated with the one or more muted regions. Additionally, the UE 115-b may refrain from monitoring for any communications in accordance with the first broadcast communication protocol during the one or more sets of time resources in accordance with the muting pattern.

Additionally, or alternatively, the muting pattern may be associated with one or more flexible regions, where the one or more flexible regions are associated with the one or more sets of time resources. In such cases, the network entity 105-c may refrain from transmission of (e.g., refrain from broadcasting) schedule CASs, MCCH messages, or MSI messages in accordance with the first broadcast communication protocol during the one or more sets of time resources in accordance (e.g., based on) with the muting pattern (e.g., associated with the one or more muted flexible regions). Additionally, in some cases, the network entity 105-c may transmit one or more data messages in accordance with the first broadcast communication protocol during the one or more sets of time resources in accordance with the muting pattern (e.g., associated with the one or more muted flexible regions). In such cases, the network entity 105-c may broadcast, outside of the one or more sets of time resources, one or more MCCH messages, one or more MSI messages, or both, scheduling the one or more data messages during the one or more sets of time resources.

Additionally, or alternatively, the modification may be a periodicity. In such cases, the network entity 105-c may broadcast the one or more subsequent CASs in accordance with the periodicity. For example, the network entity 105-c may broadcast the one or more subsequent CASs in accordance with one or more starting locations, one or more offsets, or one or more modification duration periods, where the modification further indicates the one or more starting locations, the one or more offsets, or the one or more modification duration periods.

In some examples, the network entity 105-c may broadcast a MIB during a TTI, wherein a duration of the TTI is based on the periodicity.

In some examples, the UE 115-b may receive, from an additional network entity 105, one or more signals in accordance with the second broadcast communication protocol, where a duration between the CAS and the one or more signals is based on a time threshold. The time threshold may be based on a configuration of the network entity 105-c, a configuration of the UE 115-b, or both (e.g., the network entity 105-c, the UE 115-b, or both, may be configured with the time threshold). In some examples, the one or more signals may indicate a presence or absence of one or more additional CASs communicated in accordance with the first broadcast communication protocol during one or more time resources, one or more frequency resources, or both.

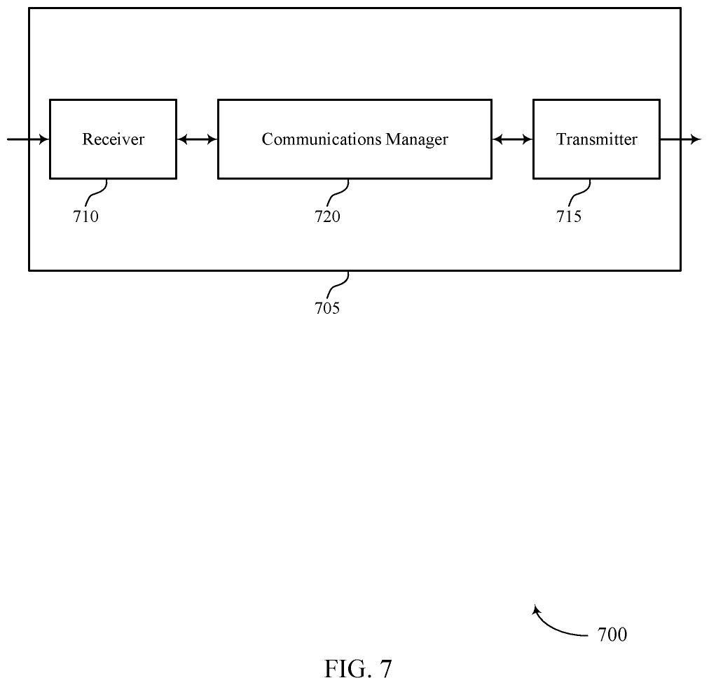

FIG. 7 illustrates a block diagram 700 of a device 705 that supports coexistence of broadcast communication protocols in accordance with one or more aspects of the present disclosure. The device 705 may be an example of aspects of a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations thereof or various components thereof may be examples of means for performing various aspects of coexistence of broadcast communication protocols as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network node in accordance with examples as disclosed herein. For example, the communications manager 720 may be configured as or otherwise support a means for broadcasting a CAS in accordance with a first broadcast communication protocol, where the CAS indicates a modification to transmission of one or more subsequent CASs in accordance with the first broadcast communication protocol. The communications manager 720 may be configured as or otherwise support a means for broadcasting, in accordance with the first broadcast communication protocol, the one or more subsequent CASs.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for coexistence of broadcast communication protocols which may result in reduced processing, reduced power consumption, and more efficient utilization of communication resources, among other advantages.

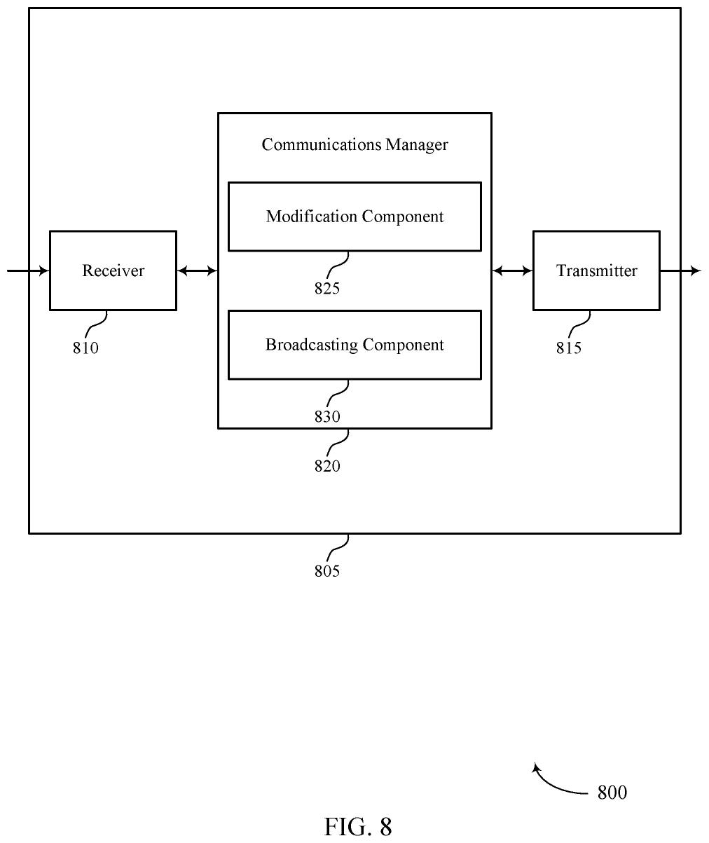

FIG. 8 illustrates a block diagram 800 of a device 805 that supports coexistence of broadcast communication protocols in accordance with one or more aspects of the present disclosure. The device 805 may be an example of aspects of a device 705 or a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of coexistence of broadcast communication protocols as described herein. For example, the communications manager 820 may include a modification component 825 a broadcasting component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first network node in accordance with examples as disclosed herein. The modification component 825 may be configured as or otherwise support a means for broadcasting a CAS in accordance with a first broadcast communication protocol, where the CAS indicates a modification to transmission of one or more subsequent CASs in accordance with the first broadcast communication protocol. The broadcasting component 830 may be configured as or otherwise support a means for broadcasting, in accordance with the first broadcast communication protocol, the one or more subsequent CASs.

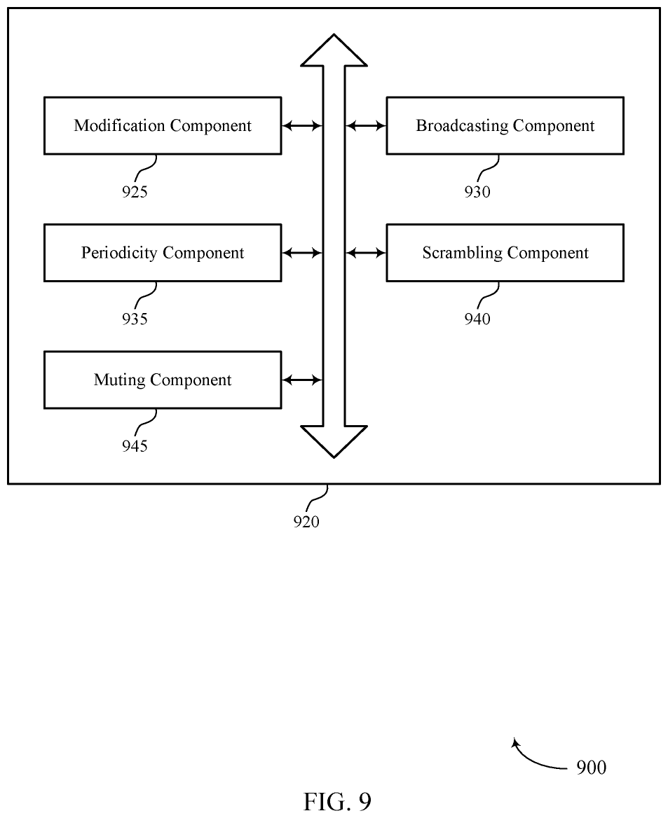

FIG. 9 illustrates a block diagram 900 of a communications manager 920 that supports coexistence of broadcast communication protocols in accordance with one or more aspects of the present disclosure. The communications manager 920 may be an example of aspects of a communications manager 720, a communications manager 820, or both, as described herein. The communications manager 920, or various components thereof, may be an example of means for performing various aspects of coexistence of broadcast communication protocols as described herein. For example, the communications manager 920 may include a modification component 925, a broadcasting component 930, a periodicity component 935, a scrambling component 940, a muting component 945, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication at a first network node in accordance with examples as disclosed herein. The modification component 925 may be configured as or otherwise support a means for broadcasting a CAS in accordance with a first broadcast communication protocol, where the CAS indicates a modification to transmission of one or more subsequent CASs in accordance with the first broadcast communication protocol. The broadcasting component 930 may be configured as or otherwise support a means for broadcasting, in accordance with the first broadcast communication protocol, the one or more subsequent CASs.

In some examples, to support broadcasting the one or more subsequent CASs, the broadcasting component 930 may be configured as or otherwise support a means for broadcasting the one or more subsequent CASs in accordance with a muting pattern, where the modification is the muting pattern, and where the muting pattern cancels transmission of scheduled CASs during one or more sets of time resources.

In some examples, the muting component 945 may be configured as or otherwise support a means for refraining from transmission of any communications in accordance with the first broadcast communication protocol during the one or more sets of time resources in accordance with the muting pattern.

In some examples, the broadcasting component 930 may be configured as or otherwise support a means for transmitting one or more data messages in accordance with the first broadcast communication protocol during the one or more sets of time resources in accordance with the muting pattern.

In some examples, the muting component 945 may be configured as or otherwise support a means for refraining from transmission of the scheduled CASs, MCCH messages, or MSI messages in accordance with the first broadcast communication protocol during the one or more sets of time resources in accordance with the muting pattern.

In some examples, the broadcasting component 930 may be configured as or otherwise support a means for broadcasting, outside of the one or more sets of time resources, one or more MCCH messages or one or more MSI messages scheduling the one or more data messages in accordance with the first broadcast communication protocol during the one or more sets of time resources.

In some examples, the CAS includes a bitmap that indicates the muting pattern.

In some examples, to support broadcasting the CAS that indicates the modification to transmission of the one or more subsequent CASs, the muting component 945 may be configured as or otherwise support a means for broadcasting an indication of the muting pattern from a set of muting patterns, where set of muting patterns is associated with a configuration of the first network node.

In some examples, to support broadcasting the one or more subsequent CASs, the periodicity component 935 may be configured as or otherwise support a means for broadcasting the one or more subsequent CASs in accordance with a periodicity, where the modification is the periodicity.

In some examples, to support broadcasting the one or more subsequent CASs, the periodicity component 935 may be configured as or otherwise support a means for broadcasting one or more MCCH messages associated with the one or more subsequent CASs in accordance with one or more starting locations, one or more offsets, or one or more modification duration periods, where the modification further indicates the one or more starting locations, the one or more offsets, or the one or more modification duration periods.

In some examples, the CAS that indicates the modification to the transmission of the one or more subsequent CASs in accordance with the first broadcast communication protocol is an anchor CAS.

In some examples, the broadcasting component 930 may be configured as or otherwise support a means for broadcasting an indication of the anchor CAS.

In some examples, the anchor CAS is based on a configuration of the first network node.

In some examples, the one or more subsequent CASs are indicated via the anchor CAS.

In some examples, the one or more subsequent CASs are associated with the anchor CAS.

In some examples, the broadcasting component 930 may be configured as or otherwise support a means for broadcasting a MIB during a TTI, where a duration of the TTI is based on the periodicity.

In some examples, time or frequency resources allocated in accordance with the first broadcast communication protocol are multiplexed, shared, or overlapped with time or frequency resources allocated in accordance with a second broadcast communication protocol. In some examples, the one or more subsequent CASs are multiplexed with communications associated with the second broadcast communication protocol in accordance with the modification.

In some examples, the CAS includes an indication that the time or frequency resources allocated for the CAS in accordance with the first broadcast communication protocol may be multiplexed, shared, or overlapped with the time or frequency resources allocated in accordance with the second broadcast communication protocol.

In some examples, the modification component 925 may be configured as or otherwise support a means for transmitting, to a second network node capable of broadcasting in accordance with the first broadcast communication protocol, an indication of the modification for use, by the second network node, in transmission of additional CASs in accordance with the first broadcast communication protocol.

In some examples, the scrambling component 940 may be configured as or otherwise support a means for applying a scrambling sequence to the CAS, where the scrambling sequence is associated with time or frequency resources allocated for the CAS in accordance with the first broadcast communication protocol being multiplexed, shared, or overlapped with time or frequency resources allocated in accordance with a second broadcast communication protocol.

In some examples, the CAS indicates the modification to the transmission of the one or more subsequent CASs in accordance with the first broadcast communication protocol via a SIB in the CAS.

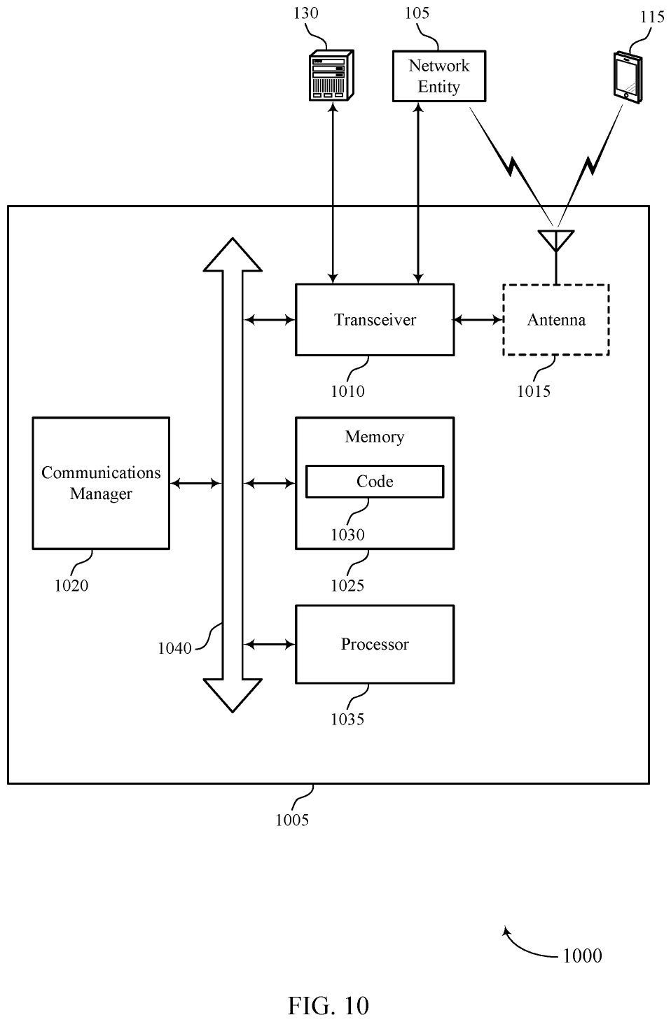

FIG. 10 illustrates a diagram of a system 1000 including a device 1005 that supports coexistence of broadcast communication protocols in accordance with one or more aspects of the present disclosure. The device 1005 may be an example of or include the components of a device 705, a device 805, or a network entity 105 as described herein. The device 1005 may communicate with one or more network entities 105, one or more UEs 115, or any combination thereof, which may include communications over one or more wired interfaces, over one or more wireless interfaces, or any combination thereof. The device 1005 may include components that support outputting and obtaining communications, such as a communications manager 1020, a transceiver 1010, an antenna 1015, a memory 1025, code 1030, and a processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or memory components (for example, the processor 1035, or the memory 1025, or both), may be included in a chip or chip assembly that is installed in the device 1005. In some examples, the transceiver may be operable to support communications via one or more communications links (e.g., a communication link 125, a backhaul communication link 120, a midhaul communication link 162, a fronthaul communication link 168).

The memory 1025 may include RAM and ROM. The memory 1025 may store computer-readable, computer-executable code 1030 including instructions that, when executed by the processor 1035, cause the device 1005 to perform various functions described herein. The code 1030 may be stored in a non-transitory computer-readable medium such as system memory or another type of memory. In some cases, the code 1030 may not be directly executable by the processor 1035 but may cause a computer (e.g., when compiled and executed) to perform functions described herein. In some cases, the memory 1025 may contain, among other things, a BIOS which may control basic hardware or software operation such as the interaction with peripheral components or devices.

The processor 1035 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1035 may be configured to operate a memory array using a memory controller. In some other cases, a memory controller may be integrated into the processor 1035. The processor 1035 may be configured to execute computer-readable instructions stored in a memory (e.g., the memory 1025) to cause the device 1005 to perform various functions (e.g., functions or tasks supporting coexistence of broadcast communication protocols). For example, the device 1005 or a component of the device 1005 may include a processor 1035 and memory 1025 coupled with the processor 1035, the processor 1035 and memory 1025 configured to perform various functions described herein. The processor 1035 may be an example of a cloud-computing platform (e.g., one or more physical nodes and supporting software such as operating systems, virtual machines, or container instances) that may host the functions (e.g., by executing code 1030) to perform the functions of the device 1005. The processor 1035 may be any one or more suitable processors capable of executing scripts or instructions of one or more software programs stored in the device 1005 (such as within the memory 1025). In some implementations, the processor 1035 may be a component of a processing system. A processing system may generally refer to a system or series of machines or components that receives inputs and processes the inputs to produce a set of outputs (which may be passed to other systems or components of, for example, the device 1005). For example, a processing system of the device 1005 may refer to a system including the various other components or subcomponents of the device 1005, such as the processor 1035, or the transceiver 1010, or the communications manager 1020, or other components or combinations of components of the device 1005. The processing system of the device 1005 may interface with other components of the device 1005, and may process information received from other components (such as inputs or signals) or output information to other components. For example, a chip or modem of the device 1005 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1005 may transmit information output from the chip or modem. Additionally, or alternatively, in some implementations, the one or more interfaces may refer to an interface between the processing system of the chip or modem and a receiver, such that the device 1005 may obtain information or signal inputs, and the information may be passed to the processing system. A person having ordinary skill in the art will readily recognize that a first interface also may obtain information or signal inputs, and a second interface also may output information or signal outputs.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the memory 1025, the code 1030, and the processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with other network entities 105, and may include a controller or scheduler for controlling communications with UEs 115 in cooperation with other network entities 105. In some examples, the communications manager 1020 may support an X2 interface within an LTE/LTE-A wireless communications network technology to provide communication between network entities 105.

The communications manager 1020 may support wireless communication at a first network node in accordance with examples as disclosed herein. For example, the communications manager 1020 may be configured as or otherwise support a means for broadcasting a CAS in accordance with a first broadcast communication protocol, where the CAS indicates a modification to transmission of one or more subsequent CASs in accordance with the first broadcast communication protocol. The communications manager 1020 may be configured as or otherwise support a means for broadcasting, in accordance with the first broadcast communication protocol, the one or more subsequent CASs.

By including or configuring the communications manager 1020 in accordance with examples as described herein, the device 1005 may support techniques for coexistence of broadcast communication protocols which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, the processor 1035, the memory 1025, the code 1030, or any combination thereof. For example, the code 1030 may include instructions executable by the processor 1035 to cause the device 1005 to perform various aspects of coexistence of broadcast communication protocols as described herein, or the processor 1035 and the memory 1025 may be otherwise configured to perform or support such operations.

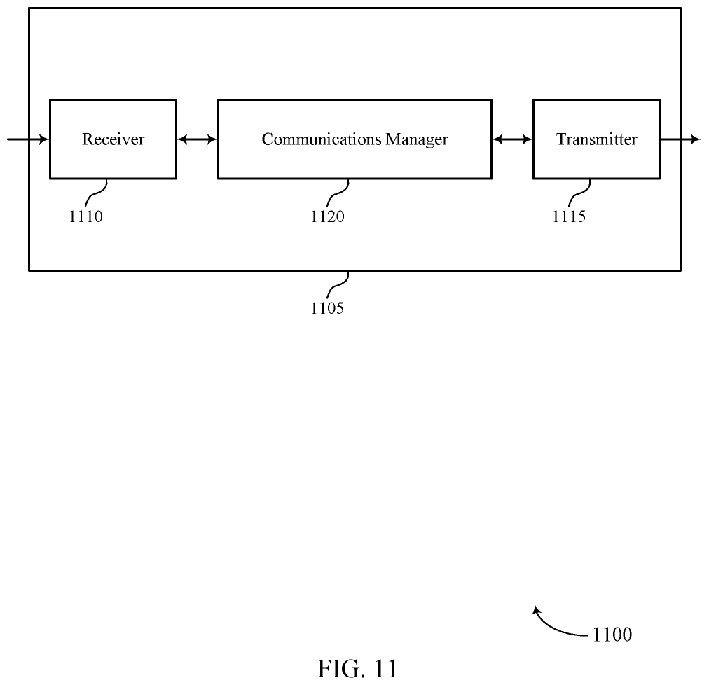

FIG. 11 illustrates a block diagram 1100 of a device 1105 that supports coexistence of broadcast communication protocols in accordance with one or more aspects of the present disclosure. The device 1105 may be an example of aspects of a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to coexistence of broadcast communication protocols). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to coexistence of broadcast communication protocols). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of coexistence of broadcast communication protocols as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first network node in accordance with examples as disclosed herein. For example, the communications manager 1120 may be configured as or otherwise support a means for receiving a CAS in accordance with a first broadcast communication protocol, where the CAS indicates a modification to transmission of one or more subsequent CASs in accordance with the first broadcast communication protocol. The communications manager 1120 may be configured as or otherwise support a means for decoding the CAS indicting the modification to transmission of the one or more subsequent CASs in accordance with the first broadcast communication protocol. The communications manager 1120 may be configured as or otherwise support a means for receiving the one or more subsequent CASs in accordance with the first broadcast communication protocol and based on the decoded CAS.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for coexistence of broadcast communication protocols which may result in reduced processing, reduced power consumption, and more efficient utilization of communication resources, among other advantages.

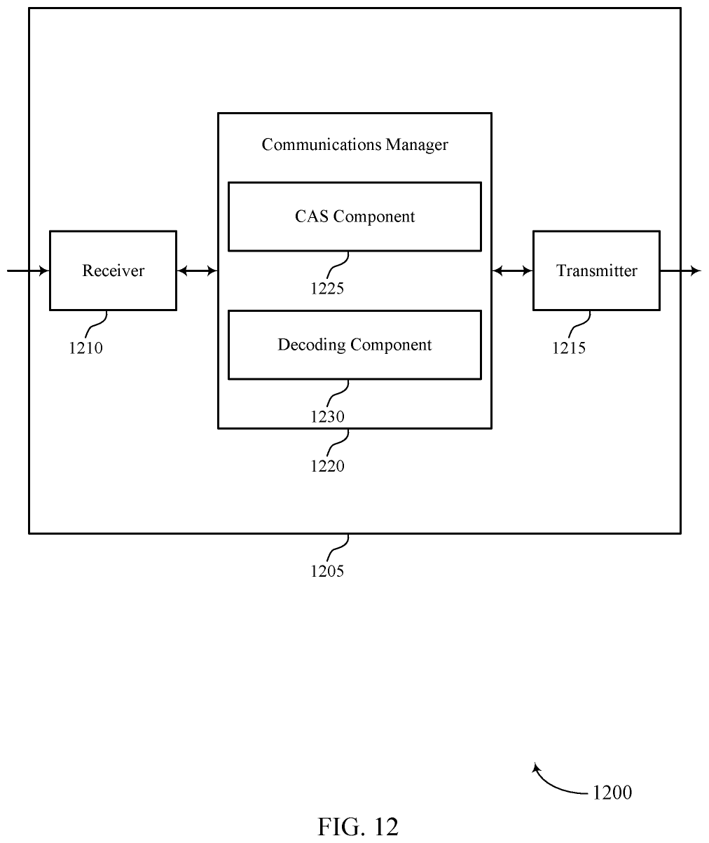

FIG. 12 illustrates a block diagram 1200 of a device 1205 that supports coexistence of broadcast communication protocols in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to coexistence of broadcast communication protocols). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to coexistence of broadcast communication protocols). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of coexistence of broadcast communication protocols as described herein. For example, the communications manager 1220 may include a CAS component 1225 a decoding component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a first network node in accordance with examples as disclosed herein. The CAS component 1225 may be configured as or otherwise support a means for receiving a CAS in accordance with a first broadcast communication protocol, where the CAS indicates a modification to transmission of one or more subsequent CASs in accordance with the first broadcast communication protocol. The decoding component 1230 may be configured as or otherwise support a means for decoding the CAS indicting the modification to transmission of the one or more subsequent CASs in accordance with the first broadcast communication protocol. The CAS component 1225 may be configured as or otherwise support a means for receiving the one or more subsequent CASs in accordance with the first broadcast communication protocol and based on the decoded CAS.

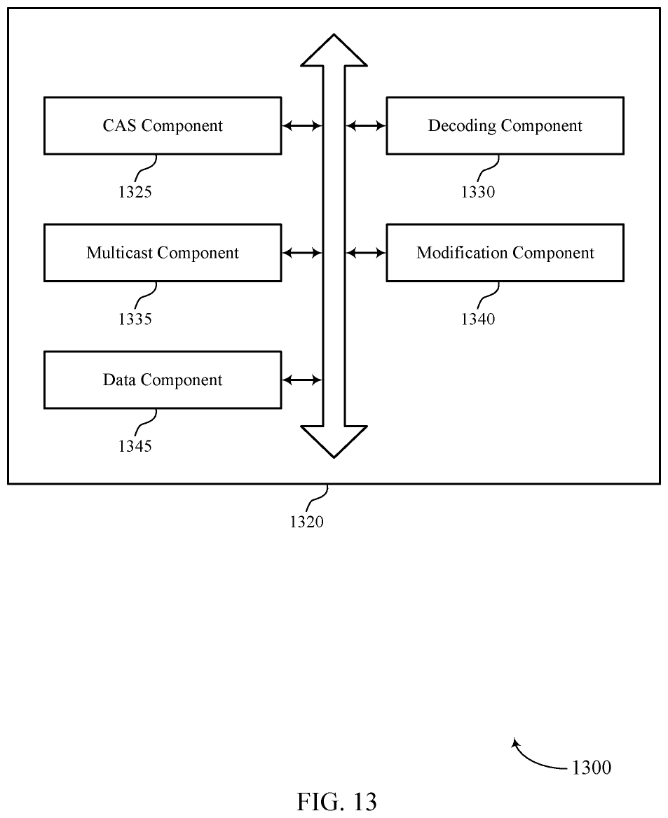

FIG. 13 illustrates a block diagram 1300 of a communications manager 1320 that supports coexistence of broadcast communication protocols in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of coexistence of broadcast communication protocols as described herein. For example, the communications manager 1320 may include a CAS component 1325, a decoding component 1330, a multicast component 1335, a modification component 1340, a data component 1345, or any combination thereof. Each of these components may communicate, directly or indirectly, with one another (e.g., via one or more buses).

The communications manager 1320 may support wireless communications at a first network node in accordance with examples as disclosed herein. The CAS component 1325 may be configured as or otherwise support a means for receiving a CAS in accordance with a first broadcast communication protocol, where the CAS indicates a modification to transmission of one or more subsequent CASs in accordance with the first broadcast communication protocol. The decoding component 1330 may be configured as or otherwise support a means for decoding the CAS indicting the modification to transmission of the one or more subsequent CASs in accordance with the first broadcast communication protocol. In some examples, the CAS component 1325 may be configured as or otherwise support a means for receiving the one or more subsequent CASs in accordance with the first broadcast communication protocol and based on the decoded CAS.

In some examples, to support receiving the one or more subsequent CASs, the CAS component 1325 may be configured as or otherwise support a means for receiving the one or more subsequent CASs in accordance with a muting pattern, where the modification is the muting pattern, and where the muting pattern indicates cancelation of transmission of scheduled CASs during one or more sets of time resources.

In some examples, the modification component 1340 may be configured as or otherwise support a means for refraining from monitoring for any communications in accordance with the first broadcast communication protocol during the one or more sets of time resources in accordance with the muting pattern.

In some examples, the data component 1345 may be configured as or otherwise support a means for receiving one or more data messages in accordance with the first broadcast communication protocol during the one or more sets of time resources in accordance with the muting pattern.

In some examples, the multicast component 1335 may be configured as or otherwise support a means for receiving, outside of the one or more sets of time resources, one or more MCCH messages or one or more MSI messages scheduling the one or more data messages in accordance with the first broadcast communication protocol during the one or more sets of time resource.

In some examples, the CAS includes a bitmap that indicates the muting pattern.

In some examples, to support receiving the CAS that indicates the modification to the transmission of the one or more subsequent CASs, the modification component 1340 may be configured as or otherwise support a means for receiving an indication of the muting pattern from a set of muting patterns, where set of muting patterns is associated with a configuration of the first network node.

In some examples, to support receiving the one or more subsequent CASs, the CAS component 1325 may be configured as or otherwise support a means for receiving the one or more subsequent CASs in accordance with a periodicity, where the modification is the periodicity.

In some examples, to support receiving the one or more subsequent CASs, the multicast component 1335 may be configured as or otherwise support a means for receiving one or more MCCH messages associated with the one or more subsequent CASs in accordance with one or more starting locations, one or more offsets, or one or more modification duration periods, where the modification further indicates the one or more starting locations, the one or more offsets, or the one or more modification duration periods.

In some examples, the CAS that indicates the modification to the transmission of the one or more subsequent CASs in accordance with the first broadcast communication protocol is an anchor CAS.

In some examples, the CAS component 1325 may be configured as or otherwise support a means for receiving an indication of the anchor CAS.

In some examples, the anchor CAS is based on a configuration of the first network node.

In some examples, the one or more subsequent CASs are indicated via the anchor CAS.

In some examples, the one or more subsequent CASs are associated with the anchor CAS.

In some examples, the multicast component 1335 may be configured as or otherwise support a means for receiving a MIB during a TTI, where a duration of the TTI is based on the periodicity.

In some examples, the modification component 1340 may be configured as or otherwise support a means for determining the modified periodicity based on testing a set of multiple candidate periodicities, where testing a candidate periodicity from the set of multiple candidate periodicities includes combining a set of CASs associated with the candidate periodicity.

In some examples, time or frequency resources allocated in accordance with the first broadcast communication protocol are multiplexed, shared, or overlapped with time or frequency resources allocated in accordance with a second broadcast communication protocol. In some examples, the one or more subsequent CASs are multiplexed with communications associated with the second broadcast communication protocol in accordance with the modification.

In some examples, the CAS includes an indication that the time or frequency resources allocated for the CAS in accordance with the first broadcast communication protocol may be multiplexed, shared, or overlapped with the time or frequency resources allocated in accordance with the second broadcast communication protocol.

In some examples, the CAS is received from a second network node, and the multicast component 1335 may be configured as or otherwise support a means for receiving, from a third network node, one or more additional CASs in accordance with the modification to transmission of the one or more subsequent CASs in accordance with the first broadcast communication protocol.

In some examples, to support decoding the CAS indicating the modification, the decoding component 1330 may be configured as or otherwise support a means for decoding the CAS based on a scrambling sequence, where the scrambling sequence is associated with time or frequency resources allocated for the CAS in accordance with the first broadcast communication protocol being multiplexed, shared, or overlapped with time or frequency resources allocated in accordance with a second broadcast communication protocol.

In some examples, the CAS indicates the modification to the transmission of the one or more subsequent CASs in accordance with the first broadcast communication protocol via a SIB in the CAS.

In some examples, the first network node is operable in accordance with both the first broadcast communication protocol and a second broadcast communication protocol.

In some examples, the CAS is received from a second network node, and the multicast component 1335 may be configured as or otherwise support a means for receiving, from a third network node, one or more signals in accordance with a second broadcast communication protocol, where a duration between the CAS and the one or more signals is based on a time threshold.

In some examples, the time threshold is based on a configuration of the first network node.

In some examples, the one or more signals indicate a presence or absence of one or more additional CASs communicated in accordance with the first broadcast communication protocol during one or more time resources, one or more frequency resources, or both.

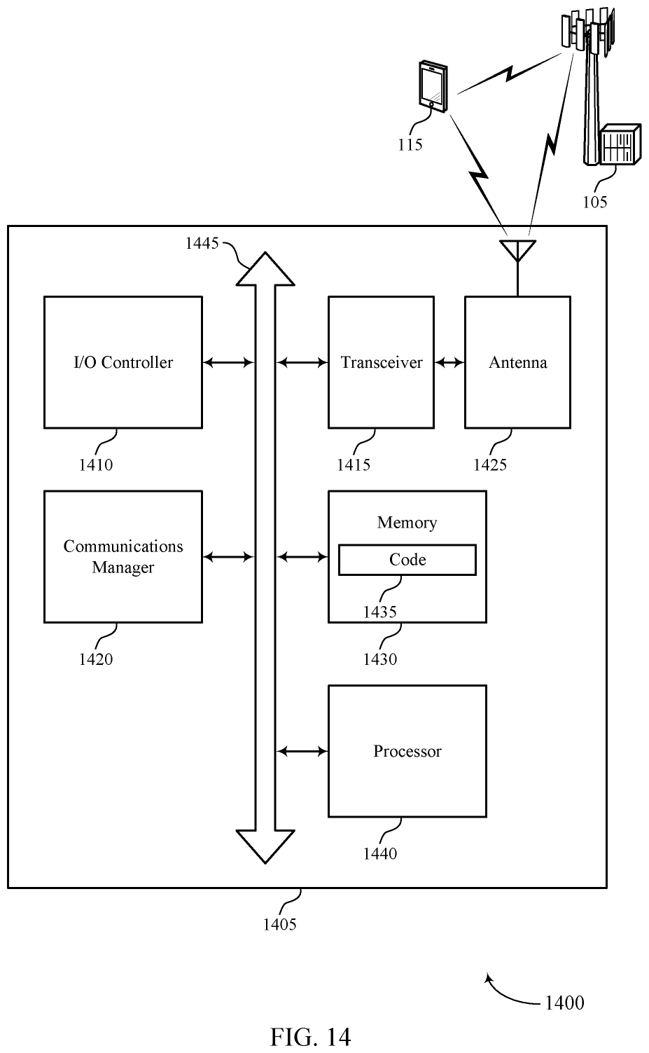

FIG. 14 illustrates a diagram of a system 1400 including a device 1405 that supports coexistence of broadcast communication protocols in accordance with one or more aspects of the present disclosure. The device 1405 may be an example of or include the components of a device 1105, a device 1205, or a UE 115 as described herein. The device 1405 may communicate (e.g., wirelessly) with one or more network entities 105, one or more UEs 115, or any combination thereof. The device 1405 may include components for bi-directional voice and data communications including components for transmitting and receiving communications, such as a communications manager 1420, an input/output (I/O) controller 1410, a transceiver 1415, an antenna 1425, a memory 1430, code 1435, and a processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another operating system. Additionally, or alternatively, the I/O controller 1410 may represent or interact with a modem, a keyboard, a mouse, a touchscreen, or a similar device. In some cases, the I/O controller 1410 may be implemented as part of a processor, such as the processor 1440. In some cases, a user may interact with the device 1405 via the I/O controller 1410 or via hardware components controlled by the I/O controller 1410.

In some cases, the device 1405 may include a single antenna 1425. However, in some other cases, the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include random access memory (RAM) and read-only memory (ROM). The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a basic I/O system (BIOS) which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting coexistence of broadcast communication protocols). For example, the device 1405 or a component of the device 1405 may include a processor 1440 and memory 1430 coupled with or to the processor 1440, the processor 1440 and memory 1430 configured to perform various functions described herein.

The communications manager 1420 may support wireless communications at a first network node in accordance with examples as disclosed herein. For example, the communications manager 1420 may be configured as or otherwise support a means for receiving a CAS in accordance with a first broadcast communication protocol, where the CAS indicates a modification to transmission of one or more subsequent CASs in accordance with the first broadcast communication protocol. The communications manager 1420 may be configured as or otherwise support a means for decoding the CAS indicting the modification to transmission of the one or more subsequent CASs in accordance with the first broadcast communication protocol. The communications manager 1420 may be configured as or otherwise support a means for receiving the one or more subsequent CASs in accordance with the first broadcast communication protocol and based on the decoded CAS.

By including or configuring the communications manager 1420 in accordance with examples as described herein, the device 1405 may support techniques for coexistence of broadcast communication protocols which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of coexistence of broadcast communication protocols as described herein, or the processor 1440 and the memory 1430 may be otherwise configured to perform or support such operations.

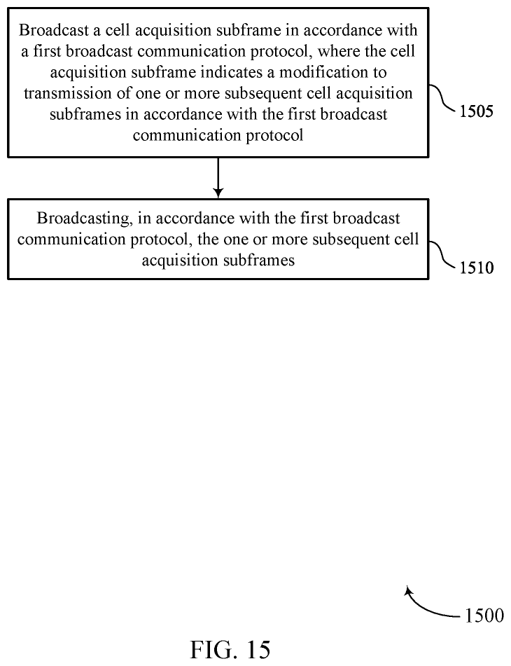

FIG. 15 illustrates a flowchart showing a method 1500 that supports coexistence of broadcast communication protocols in accordance with one or more aspects of the present disclosure. The operations of the method 1500 may be implemented by a network entity or its components as described herein. For example, the operations of the method 1500 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1505, the method may include broadcasting a CAS in accordance with a first broadcast communication protocol, where the CAS indicates a modification to transmission of one or more subsequent CASs in accordance with the first broadcast communication protocol. The operations of 1505 may be performed in accordance with examples as disclosed herein. In some examples, aspects of the operations of 1505 may be performed by a modification component 925 as described with reference to FIG. 9.

At 1510, the method may include broadcasting, in accordance with the first broadcast communication protocol, the one or more subsequent CASs. The operations of 1510 may be performed in accordance with examples as disclosed herein. In some examples, aspects of the operations of 1510 may be performed by a broadcasting component 930 as described with reference to FIG. 9.

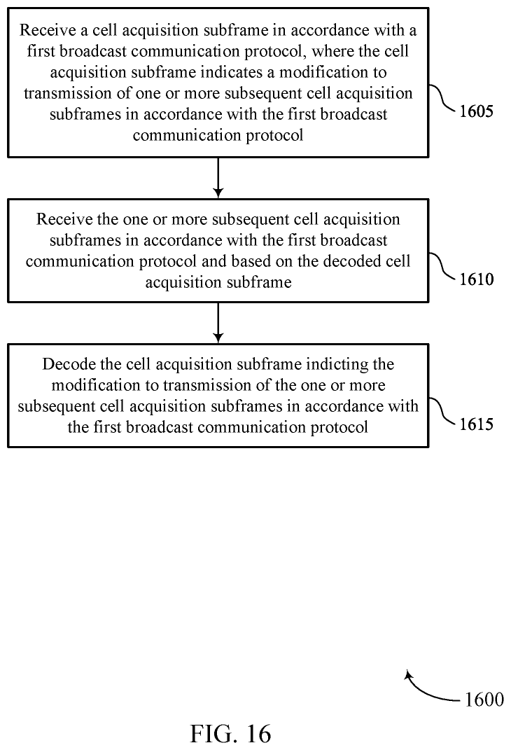

FIG. 16 illustrates a flowchart showing a method 1600 that supports coexistence of broadcast communication protocols in accordance with one or more aspects of the present disclosure. The operations of the method 1600 may be implemented by a UE or its components as described herein. For example, the operations of the method 1600 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1605, the method may include receiving a CAS in accordance with a first broadcast communication protocol, where the CAS indicates a modification to transmission of one or more subsequent CASs in accordance with the first broadcast communication protocol. The operations of 1605 may be performed in accordance with examples as disclosed herein. In some examples, aspects of the operations of 1605 may be performed by a CAS component 1325 as described with reference to FIG. 13.

At 1610, the method may include receiving the one or more subsequent CASs in accordance with the first broadcast communication protocol and based on the decoded CAS. The operations of 1610 may be performed in accordance with examples as disclosed herein. In some examples, aspects of the operations of 1610 may be performed by a CAS component 1325 as described with reference to FIG. 13.

At 1615, the method may include decoding the CAS indicting the modification to transmission of the one or more subsequent CASs in accordance with the first broadcast communication protocol. The operations of 1615 may be performed in accordance with examples as disclosed herein. In some examples, aspects of the operations of 1615 may be performed by a decoding component 1330 as described with reference to FIG. 13.

The following provides an overview of aspects of the present disclosure:
Aspect 1: A method for wireless communication at a first network node, comprising: broadcasting a CAS in accordance with a first broadcast communication protocol, wherein the CAS indicates a modification to transmission of one or more subsequent CASs in accordance with the first broadcast communication protocol; and broadcasting, in accordance with the first broadcast communication protocol, the one or more subsequent CASs.
Aspect 2: The method of aspect 1, wherein broadcasting the one or more subsequent CASs comprises: broadcasting the one or more subsequent CASs in accordance with a muting pattern, wherein the modification is the muting pattern, and wherein the muting pattern cancels transmission of scheduled CASs during one or more sets of time resources.
Aspect 3: The method of aspect 2, further comprising: refraining from transmission of any communications in accordance with the first broadcast communication protocol during the one or more sets of time resources in accordance with the muting pattern.
Aspect 4: The method of aspect 2, further comprising: transmitting one or more data messages in accordance with the first broadcast communication protocol during the one or more sets of time resources in accordance with the muting pattern.
Aspect 5: The method of aspect 4, further comprising: refraining from transmission of the scheduled CASs, MCCH messages, or MSI messages in accordance with the first broadcast communication protocol during the one or more sets of time resources in accordance with the muting pattern.
Aspect 6: The method of any of aspects 4 through 5, further comprising: broadcasting, outside of the one or more sets of time resources, one or more MCCH messages or one or more MSI messages scheduling the one or more data messages in accordance with the first broadcast communication protocol during the one or more sets of time resources.
Aspect 7: The method of any of aspects 2 through 6, wherein the CAS comprises a bitmap that indicates the muting pattern.
Aspect 8: The method of any of aspects 2 through 7, wherein broadcasting the CAS that indicates the modification to transmission of the one or more subsequent CASs comprises: broadcasting an indication of the muting pattern from a set of muting patterns, wherein set of muting patterns is associated with a configuration of the first network node.
Aspect 9: The method of any of aspects 1 through 8, wherein broadcasting the one or more subsequent CASs comprises: broadcasting the one or more subsequent CASs in accordance with a periodicity, wherein the modification is the periodicity.
Aspect 10: The method of aspect 9, wherein broadcasting the one or more subsequent CASs comprises: broadcasting one or more MCCH messages associated with the one or more subsequent CASs in accordance with one or more starting locations, one or more offsets, or one or more modification duration periods, wherein the modification further indicates the one or more starting locations, the one or more offsets, or the one or more modification duration periods.
Aspect 11: The method of any of aspects 9 through 10, wherein the CAS that indicates the modification to the transmission of the one or more subsequent CASs in accordance with the first broadcast communication protocol is an anchor CAS.
Aspect 12: The method of aspect 11, further comprising: broadcasting an indication of the anchor CAS.
Aspect 13: The method of aspect 11, wherein the anchor CAS is based on a configuration of the first network node.
Aspect 14: The method of any of aspects 11 through 13, wherein the one or more subsequent CASs are indicated via the anchor CAS.
Aspect 15: The method of any of aspects 11 through 13, wherein the one or more subsequent CASs are associated with the anchor CAS.
Aspect 16: The method of any of aspects 9 through 15, further comprising: broadcasting a MIB during a TTI, wherein a duration of the TTI is based on the periodicity.
Aspect 17: The method of any of aspects 1 through 16, wherein time or frequency resources allocated in accordance with the first broadcast communication protocol are multiplexed, shared, or overlapped with time or frequency resources allocated in accordance with a second broadcast communication protocol, and the one or more subsequent CASs are multiplexed with communications associated with the second broadcast communication protocol in accordance with the modification.
Aspect 18: The method of aspect 17, wherein the CAS comprises an indication that the time or frequency resources allocated for the CAS in accordance with the first broadcast communication protocol may be multiplexed, shared, or overlapped with the time or frequency resources allocated in accordance with the second broadcast communication protocol.
Aspect 19: The method of any of aspects 1 through 18, further comprising: transmitting, to a second network node capable of broadcasting in accordance with the first broadcast communication protocol, an indication of the modification for use, by the second network node, in transmission of additional CASs in accordance with the first broadcast communication protocol.
Aspect 20: The method of any of aspects 1 through 19, further comprising: applying a scrambling sequence to the CAS, wherein the scrambling sequence is associated with time or frequency resources allocated for the CAS in accordance with the first broadcast communication protocol being multiplexed, shared, or overlapped with time or frequency resources allocated in accordance with a second broadcast communication protocol.
Aspect 21: The method of any of aspects 1 through 20, wherein the CAS indicates the modification to the transmission of the one or more subsequent CASs in accordance with the first broadcast communication protocol via a SIB in the CAS.
Aspect 22: A method for wireless communications at a first network node, comprising: receiving a CAS in accordance with a first broadcast communication protocol, wherein the CAS indicates a modification to transmission of one or more subsequent CASs in accordance with the first broadcast communication protocol; decoding the CAS indicting the modification to transmission of the one or more subsequent CASs in accordance with the first broadcast communication protocol; and receiving the one or more subsequent CASs in accordance with the first broadcast communication protocol and based on the decoded CAS.
Aspect 23: The method of aspect 22, wherein receiving the one or more subsequent CASs comprises: receiving the one or more subsequent CASs in accordance with a muting pattern, wherein the modification is the muting pattern, and wherein the muting pattern indicates cancelation of transmission of scheduled CASs during one or more sets of time resources.
Aspect 24: The method of aspect 23, further comprising: refraining from monitoring for any communications in accordance with the first broadcast communication protocol during the one or more sets of time resources in accordance with the muting pattern.
Aspect 25: The method of aspect 23, further comprising: receiving one or more data messages in accordance with the first broadcast communication protocol during the one or more sets of time resources in accordance with the muting pattern.
Aspect 26: The method of aspect 25, further comprising: receiving, outside of the one or more sets of time resources, one or more MCCH messages or one or more MSI messages scheduling the one or more data messages in accordance with the first broadcast communication protocol during the one or more sets of time resource.
Aspect 27: The method of any of aspects 23 through 26, wherein the CAS comprises a bitmap that indicates the muting pattern.
Aspect 28: The method of any of aspects 23 through 27, wherein receiving the CAS that indicates the modification to the transmission of the one or more subsequent CASs comprises: receiving an indication of the muting pattern from a set of muting patterns, wherein set of muting patterns is associated with a configuration of the first network node.
Aspect 29: The method of any of aspects 22 through 28, wherein receiving the one or more subsequent CASs comprises: receiving the one or more subsequent CASs in accordance with a periodicity, wherein the modification is the periodicity.
Aspect 30: The method of aspect 29, wherein receiving the one or more subsequent CASs comprises: receiving one or more MCCH messages associated with the one or more subsequent CASs in accordance with one or more starting locations, one or more offsets, or one or more modification duration periods, wherein the modification further indicates the one or more starting locations, the one or more offsets, or the one or more modification duration periods.
Aspect 31: The method of any of aspects 29 through 30, wherein the CAS that indicates the modification to the transmission of the one or more subsequent CASs in accordance with the first broadcast communication protocol is an anchor CAS.
Aspect 32: The method of aspect 31, further comprising: receiving an indication of the anchor CAS.
Aspect 33: The method of aspect 31, wherein the anchor CAS is based on a configuration of the first network node.
Aspect 34: The method of any of aspects 31 through 33, wherein the one or more subsequent CASs are indicated via the anchor CAS.
Aspect 35: The method of any of aspects 31 through 33, wherein the one or more subsequent CASs are associated with the anchor CAS.
Aspect 36: The method of any of aspects 29 through 35, further comprising: receiving a MIB during a TTI, wherein a duration of the TTI is based on the periodicity.
Aspect 37: The method of any of aspects 29 through 36, further comprising: determining the modified periodicity based on testing a plurality of candidate periodicities, wherein testing a candidate periodicity from the plurality of candidate periodicities comprises combining a set of CASs associated with the candidate periodicity.
Aspect 38: The method of any of aspects 22 through 37, wherein time or frequency resources allocated in accordance with the first broadcast communication protocol are multiplexed, shared, or overlapped with time or frequency resources allocated in accordance with a second broadcast communication protocol, and the one or more subsequent CASs are multiplexed with communications associated with the second broadcast communication protocol in accordance with the modification.
Aspect 39: The method of aspect 38, wherein the CAS comprises an indication that the time or frequency resources allocated for the CAS in accordance with the first broadcast communication protocol may be multiplexed, shared, or overlapped with the time or frequency resources allocated in accordance with the second broadcast communication protocol.
Aspect 40: The method of any of aspects 22 through 39, wherein the CAS is received from a second network node, the method further comprising: receiving, from a third network node, one or more additional CASs in accordance with the modification to transmission of the one or more subsequent CASs in accordance with the first broadcast communication protocol.
Aspect 41: The method of any of aspects 22 through 40, wherein decoding the CAS indicating the modification comprises: decoding the CAS based on a scrambling sequence, wherein the scrambling sequence is associated with time or frequency resources allocated for the CAS in accordance with the first broadcast communication protocol being multiplexed, shared, or overlapped with time or frequency resources allocated in accordance with a second broadcast communication protocol.
Aspect 42: The method of any of aspects 22 through 41, wherein the CAS indicates the modification to the transmission of the one or more subsequent CASs in accordance with the first broadcast communication protocol via a SIB in the CAS.
Aspect 43: The method of any of aspects 22 through 42, wherein the first network node is operable in accordance with both the first broadcast communication protocol and a second broadcast communication protocol.
Aspect 44: The method of any of aspects 22 through 43, wherein the CAS is received from a second network node, the method further comprising: receiving, from a third network node, one or more signals in accordance with a second broadcast communication protocol, where a duration between the CAS and the one or more signals is based on a time threshold.
Aspect 45: The method of aspect 44, wherein the time threshold is based on a configuration of the first network node.
Aspect 46: The method of any of aspects 44 through 45, wherein the one or more signals indicate a presence or absence of one or more additional CASs communicated in accordance with the first broadcast communication protocol during one or more time resources, one or more frequency resources, or both.
Aspect 47: A first network node, comprising a memory and at least one processor coupled to the memory, wherein the at least one processor is configured to perform a method of any of aspects 1 through 21.
Aspect 48: An apparatus for wireless communication at a first network node, comprising at least one means for performing a method of any of aspects 1 through 21.
Aspect 49: A non-transitory computer-readable medium having code for wireless communication stored thereon that, when executed by a network node, causes the network node to perform a method of any of aspects 1 through 21.
Aspect 50: A first network node, comprising a memory and at least one processor coupled to the memory, wherein the at least one processor is configured to perform a method of any of aspects 22 through 46.
Aspect 51: An apparatus for wireless communications at a first network node, comprising at least one means for performing a method of any of aspects 22 through 46.
Aspect 52: A non-transitory computer-readable medium having code for wireless communication stored thereon that, when executed by a network node, causes the network node to perform a method of any of aspects 22 through 46.

The methods described herein describe possible implementations, and the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C. X being based on A and B. X being based on A and C. X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
broadcast a cell acquisition subframe in accordance with a first broadcast communication protocol, wherein the cell acquisition subframe indicates a modification to transmission of one or more subsequent cell acquisition subframes in accordance with the first broadcast communication protocol; and
broadcasting, in accordance with the first broadcast communication protocol, the one or more subsequent cell acquisition subframes.

2. The first network node of claim 1, wherein, to broadcast the one or more subsequent cell acquisition subframes, the at least one processor is configured to:
broadcast the one or more subsequent cell acquisition subframes in accordance with a muting pattern, wherein the modification is the muting pattern, and wherein the muting pattern cancels transmission of scheduled cell acquisition subframes during one or more sets of time resources.

3. The first network node of claim 2, wherein the at least one processor is further configured to:
refrain from transmission of any communications in accordance with the first broadcast communication protocol during the one or more sets of time resources in accordance with the muting pattern.

4. The first network node of claim 2, wherein the at least one processor is further configured to:
transmit one or more data messages in accordance with the first broadcast communication protocol during the one or more sets of time resources in accordance with the muting pattern.

5. The first network node of claim 4, wherein the at least one processor is further configured to:
refrain from transmission of the scheduled cell acquisition subframes, multicast control channel messages, or multicast scheduling information messages in accordance with the first broadcast communication protocol during the one or more sets of time resources in accordance with the muting pattern.

6. The first network node of claim 1, wherein, to broadcast the one or more subsequent cell acquisition subframes, the at least one processor is configured to:
broadcast the one or more subsequent cell acquisition subframes in accordance with a periodicity, wherein the modification is the periodicity.

7. The first network node of claim 6, wherein the cell acquisition subframe that indicates the modification to the transmission of the one or more subsequent cell acquisition subframes in accordance with the first broadcast communication protocol is an anchor cell acquisition subframe.

8. The first network node of claim 7, wherein the anchor cell acquisition subframe is based on a configuration of the first network node.

9. The first network node of claim 7, wherein the one or more subsequent cell acquisition subframes are indicated via the anchor cell acquisition subframe.

10. The first network node of claim 7, wherein the one or more subsequent cell acquisition subframes are associated with the anchor cell acquisition subframe.

11. The first network node of claim 1, wherein the at least one processor is further configured to:
apply a scrambling sequence to the cell acquisition subframe, wherein the scrambling sequence is associated with time or frequency resources allocated for the cell acquisition subframe in accordance with the first broadcast communication protocol being multiplexed, shared or overlapped with time or frequency resources allocated in accordance with a second broadcast communication protocol.

12. A first network node for wireless communication, comprising:
a memory; and
at least one processor coupled to the memory, wherein the at least one processor is configured to:
receive a cell acquisition subframe in accordance with a first broadcast communication protocol, wherein the cell acquisition subframe indicates a modification to transmission of one or more subsequent cell acquisition subframes in accordance with the first broadcast communication protocol;
decode the cell acquisition subframe indicting the modification to transmission of the one or more subsequent cell acquisition subframes in accordance with the first broadcast communication protocol; and
receive the one or more subsequent cell acquisition subframes in accordance with the first broadcast communication protocol and based on the decoded cell acquisition subframe.

13. The first network node of claim 12, wherein, to receive the one or more subsequent cell acquisition subframes, the at least one processor is configured to:
receive the one or more subsequent cell acquisition subframes in accordance with a muting pattern, wherein the modification is the muting pattern, and wherein the muting pattern indicates cancelation of transmission of scheduled cell acquisition subframes during one or more sets of time resources.

14. The first network node of claim 13, wherein the at least one processor is further configured to:
refrain from monitoring for any communications in accordance with the first broadcast communication protocol during the one or more sets of time resources in accordance with the muting pattern.

15. The first network node of claim 13, wherein the at least one processor is further configured to:
receive one or more data messages in accordance with the first broadcast communication protocol during the one or more sets of time resources in accordance with the muting pattern.

16. The first network node of claim 15, wherein the at least one processor is further configured to:
receive, outside of the one or more sets of time resources, one or more multicast control channel messages or one or more multicast scheduling information messages scheduling the one or more data messages in accordance with the first broadcast communication protocol during the one or more sets of time resource.

17. The first network node of claim 12, wherein, to receive the one or more subsequent cell acquisition subframes, the at least one processor is configured to:
receive the one or more subsequent cell acquisition subframes in accordance with a periodicity, wherein the modification is the periodicity.

18. The first network node of claim 17, wherein, to receive the one or more subsequent cell acquisition subframes, the at least one processor is configured to:
receive one or more multicast control channel messages associated with the one or more subsequent cell acquisition subframes in accordance with one or more starting locations, one or more offsets, or one or more modification duration periods, wherein the modification further indicates the one or more starting locations, the one or more offsets, or the one or more modification duration periods.

19. The first network node of claim 17, wherein the cell acquisition subframe that indicates the modification to the transmission of the one or more subsequent cell acquisition subframes in accordance with the first broadcast communication protocol is an anchor cell acquisition subframe.

20. The first network node of claim 19, wherein the anchor cell acquisition subframe is based on a configuration of the first network node.

21. The first network node of claim 19, wherein the one or more subsequent cell acquisition subframes are indicated via the anchor cell acquisition subframe.

22. The first network node of claim 19, wherein the one or more subsequent cell acquisition subframes are associated with the anchor cell acquisition subframe.

23. The first network node of claim 17, wherein the at least one processor is further configured to:
determine the modified periodicity based on testing a plurality of candidate periodicities, wherein testing a candidate periodicity from the plurality of candidate periodicities comprises combining a set of cell acquisition subframes associated with the candidate periodicity.

24. The first network node of claim 12, wherein the cell acquisition subframe is received from a second network node, and wherein the at least one processor is further configured to:
receive, from a third network node, one or more additional cell acquisition subframes in accordance with the modification to transmission of the one or more subsequent cell acquisition subframes in accordance with the first broadcast communication protocol.

25. The first network node of claim 12, wherein, to decode the cell acquisition subframe indicating the modification, the at least one processor is configured to:
decode the cell acquisition subframe based on a scrambling sequence, wherein the scrambling sequence is associated with time or frequency resources allocated for the cell acquisition subframe in accordance with the first broadcast communication protocol being multiplexed, shared, or overlapped with time or frequency resources allocated in accordance with a second broadcast communication protocol.

26. The first network node of claim 12, wherein the cell acquisition subframe is received from a second network node, and wherein the at least one processor is further configured to:
receive, from a third network node, one or more signals in accordance with a second broadcast communication protocol, where a duration between the cell acquisition subframe and the one or more signals is based on a time threshold.

27. The first network node of claim 26, wherein the time threshold is based on a configuration of the first network node.

28. The first network node of claim 26, wherein the one or more signals indicate a presence or absence of one or more additional cell acquisition subframes communicated in accordance with the first broadcast communication protocol during one or more time resources, one or more frequency resources, or both.

29. A method for wireless communication at a first network node, comprising:
broadcasting a cell acquisition subframe in accordance with a first broadcast communication protocol, wherein the cell acquisition subframe indicates a modification to transmission of one or more subsequent cell acquisition subframes in accordance with the first broadcast communication protocol; and
broadcasting, in accordance with the first broadcast communication protocol, the one or more subsequent cell acquisition subframes.

30. A method for wireless communications at a first network node, comprising:
receiving a cell acquisition subframe in accordance with a first broadcast communication protocol, wherein the cell acquisition subframe indicates a modification to transmission of one or more subsequent cell acquisition subframes in accordance with the first broadcast communication protocol;
decoding the cell acquisition subframe indicting the modification to transmission of the one or more subsequent cell acquisition subframes in accordance with the first broadcast communication protocol; and
receiving the one or more subsequent cell acquisition subframes in accordance with the first broadcast communication protocol and based on the decoded cell acquisition subframe.
